(19) United States
(12) Patent Application Publication
(10) Pub. No.: US 2018/0278948 A1
(43) Pub. Date: Sep. 27, 2018

(54) TILE-BASED PROCESSING FOR VIDEO CODING

(71) Applicant: QUALCOMM Incorporated, San Diego, CA (US)

(72) Inventors: Yasutomo Matsuba, San Diego, CA (US); Hariharan Ganesh Lalgudi, San Diego, CA (US); Yunqing Chen, Campbell, CA (US); Vladan Andrijanic, San Diego, CA (US); Shyamprasad Chikkerur, San Diego, CA (US); Harikrishna Reddy, San Jose, CA (US); Kai Wang, San Diego, CA (US)

(21) Appl. No.: 15/467,841

(22) Filed: Mar. 23, 2017

(51) Int. Cl. H04N 19/513; H04N 19/15; H04N 19/159; H04N 19/436; H04N 19/91; H04N 19/124

(52) U.S. Cl. CPC H04N 19/513; H04N 19/15; H04N 19/159; H04N 19/176; H04N 19/91; H04N 19/124; H04N 19/436

(57) ABSTRACT

Example video encoding techniques are described. A video encoder may generate residual data for macroblocks for tiles of a current frame. Each tile includes a plurality of macroblocks, each tile is independently encoded from the other tiles of the current frame, and a width of each tile is less than a width of the current frame. The video encoder may store the residual data in buffers. Each buffer is associated with one or more tiles, and each buffer is configured to store residual data for macroblocks for the one or more tiles with which each buffer is associated. The video encoder may read the residual data from the plurality of buffers for macroblocks of an entire row of the current frame before reading residual data from the plurality of buffers for macroblocks of any other row of the current frame, and encode values based on the read residual data.

### TECHNICAL FIELD

This disclosure relates to video encoding and decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicates the difference between the coded block and the predictive block. An intra-coded block is encoded according to an intra-coding mode and the residual data. For further compression, the residual data may be transformed from the pixel domain to a transform domain, resulting in residual coefficients, which then may be quantized.

### SUMMARY

In general, the disclosure describes techniques for performing tile-based video encoding. In tile-based video encoding, a video frame or picture is divided into a plurality of tiles, which may be rectangular in shape. Each tile includes a plurality of blocks, and each tile is individually encodable and decodable. The size of each tile is less than the entire width or entire row of the video frame or picture. Because size of each tile is less than the entire width or entire row, the size of memory (e.g., cache width or length) may be smaller than examples where an entire width or row needs to be stored.

However, in some video encoding techniques, the video bit-stream generated from the encoding of a video frame may be required to be generated on a row-by-row basis, rather than a tile-by-tile basis. The example techniques described in this disclosure may provide for a way to perform tile-based encoding, but still conform to the bit-stream requirements of various video encoding techniques. Although the video frame may have been intra- or inter-predicted in tile-based techniques, the residual data generated from the intra- or inter-prediction may be encoded (e.g., entropy encoded) by reading row-by-row. For instance, a video encoder may read across all first rows of residual data for each tile, followed by all second rows of residual data for each tile, and so forth. Furthermore, the video encoder may limit available prediction modes or available prediction blocks for certain blocks of a tile to allow conformance for various video coding techniques.

In one example, the disclosure describes a method of encoding video data, the method comprising generating residual data for macroblocks for a plurality of tiles of a current frame, wherein each tile includes a plurality of macroblocks, wherein each tile is independently encoded from the other tiles of the current frame, and wherein a width of each tile is less than a width of the current frame, storing the residual data in a plurality of buffers, wherein each buffer is associated with one or more tiles, and wherein each buffer is configured to store residual data for macroblocks for the one or more tiles with which each buffer is associated, reading the residual data from the plurality of buffers for macroblocks of an entire row of the current frame before reading residual data from the plurality of buffers for macroblocks of any other row of the current frame, and encoding values based on the read residual data.

In one example, the disclosure describes a device for encoding video data, the device comprising a plurality of buffers, and one or more pixel processing circuits configured to generate residual data for macroblocks for a plurality of tiles of a current frame, wherein each tile includes a plurality of macroblocks, wherein each tile is independently encoded from the other tiles of the current frame, and wherein a width of each tile is less than a width of the current frame, and store the residual data in the plurality of buffers, wherein each buffer is associated with one or more tiles, and wherein each buffer is configured to store residual data for macroblocks for the one or more tiles with which each buffer is associated. The device further comprising a bit-stream generation circuit configured to read the residual data from the plurality of buffers for macroblocks of an entire row of the current frame before reading residual data from the plurality of buffers for macroblocks of any other row of the current frame, and encode values based on the read residual data.

In one example, the disclosure describes a device for encoding video data, the device comprising means for generating residual data for macroblocks for a plurality of tiles of a current frame, wherein each tile includes a plurality of macroblocks, wherein each tile is independently encoded from the other tiles of the current frame, and wherein a width of each tile is less than a width of the current frame, means for storing the residual data in a plurality of buffers, wherein each buffer is associated with one or more tiles, and wherein each buffer is configured to store residual data for macroblocks for the one or more tiles with which each buffer is associated, means for reading the residual data from the plurality of buffers for macroblocks of an entire row of the current frame before reading residual data from the plurality of buffers for macroblocks of any other row of the current frame, and means for encoding values based on the read residual data.

In one example, the disclosure describes a computer-readable storage medium storing instruction that when executed cause one or more processors of a device for encoding video data to generate residual data for macroblocks for a plurality of tiles of a current frame, wherein each tile includes a plurality of macroblocks, wherein each tile is independently encoded from the other tiles of the current frame, and wherein a width of each tile is less than a width of the current frame, store the residual data in a plurality of buffers, wherein each buffer is associated with one or more tiles, and wherein each buffer is configured to store residual data for macroblocks for the one or more tiles with which each buffer is associated, read the residual data from the plurality of buffers for macroblocks of an entire row of the current frame before reading residual data from the plurality of buffers for macroblocks of any other row of the current frame, and encode values based on the read residual data.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video coding system that may utilize the techniques described in this disclosure.

FIG. 2 is a block diagram illustrating an example video encoder that may implement the techniques described in this disclosure.

FIG. 3 is a conceptual diagram illustrating an example cache storing video data.

FIG. 4 is a block diagram illustrating an example video decoder that may implement the techniques described in this disclosure.

FIG. 5A is a block diagram illustrating an example of generating tile-based video data for video encoding.

FIG. 5B is a block diagram illustrating another example of generating tile-based video data for video encoding.

FIG. 5C is a conceptual diagram illustrating storage of video data in tile-by-tile format for video encoding.

FIG. 5D is a conceptual diagram illustrating reading of video data stored in tile-by-tile format for video encoding.

FIG. 6A is a block diagram illustrating an example of processing tile-based video data for video decoding.

FIG. 6B is a block diagram illustrating another example of processing tile-based video data for video encoding.

FIG. 6C is a conceptual diagram illustrating reading of video data in tile-by-tile format for video decoding.

FIG. 6D is a conceptual diagram illustrating storage of video data in tile-by-tile format for video decoding.

FIG. 7 is a conceptual diagram illustrating last macroblocks in each row of a plurality of tiles.

FIG. 8 is a conceptual diagram illustrating examples for processing last macroblocks in each row of a plurality of tiles.

FIG. 9 is a flowchart illustrating an example operation of processing video data.

### DETAILED DESCRIPTION

In video coding, for inter-prediction, a predictive block is identified in a search space of a reference picture, which requires a memory that stores video data of a reference picture to identify the predictive block. In the H.264 and VP8 video coding standards, a memory stores entire rows of pixel sample values for reference pictures. However, in the H.265 (High Efficiency Video Coding (HEVC)) and VP9 video coding standards, a memory may store a row of pixel sample values of a tile of the reference picture, rather than pixel sample values of an entire row.

HEVC and VP9 allow for tile-based video coding, where a picture is divided into tiles, and each tile is independently (e.g., in parallel without access to other tiles) encoded and decoded. The benefits of tiled based video coding include encoding and decoding in parallel. For example, tile parallel process allows separation of load of processing into tiles. For example, without tiles, one 4K 60 frames-per-second (fps) video hardware accelerator is needed to encode 4K 60 fps video data. If the 4K video is separated into 4 tiles (each one is 1K), then to encode 4K 60 fps, four 1K60 fps video hardware accelerators may be needed.

The citation for the H.264 standard is: ITU-T H.264, Series H: Audiovisual and Multimedia Systems, Infrastructure of audiovisual services—Coding of moving video, Advanced video coding for generic audiovisual services, The International Telecommunication Union. June 2011. The citation for the H.265 (HEVC) standard is: ITU-T H.265, Series H: Audiovisual and Multimedia Systems, Infrastructure of audiovisual services—Coding of moving video, Advanced video coding for generic audiovisual services, The International Telecommunication Union. April 2015. The citation of the VP8 standard is: VP8 Data Format and Decoding Guide, RFC 6386, November 2011, ISSN: 2070-1721. The citation of the VP9 standard is: VP9 Bit-stream & Decoding Process Specification—v0.6, March 2016.

In some examples, if the tiles are processed sequentially, the cache size may be limited to the tile width, instead of the width of the entire frame. Because each tile is smaller than the width of the entire frame, the amount of reference picture video data that is needed may be limited. For instance, the amount of video data in a row of a tile is less than the amount of video data in a row of a frame, hence a smaller cache may be usable for tile-based video coding as compared to other non-tile based video coding techniques.

The example techniques described in this disclosure provide ways to implement tiled-based video coding for H.264 and VP8. For example, the pixel processing circuit (including reference pixel fetching) may read reference pixels and process pixels in tile order (e.g., one tile at a time, instead of an entire row). The pixel processing circuit may store the video data (e.g., residual data or processed residual data) in tile order. A bit-stream generation circuit may then read the residual or processed residual data for entropy encoding. However, for conformance with the H.264 and VP8 video coding standards, the bit-stream generation circuit may read the data in row order. For instance, rather than reading the video data for one entire tile, the bit-stream generation circuit may read pixel values for a row of a first tile, then a row of a second tile, and so forth. This way, the bit-stream generation circuit generates the bit-stream in row-by-row of the entire frame, which is needed for H.264 or VP8, but is able to use tile-based encoding.

A video decoder may receive the bit-stream, and perform the inverse process for decoding (e.g., divide the data into tiles and decode per tile). For instance, a bit-stream processing circuit of the video decoder may entropy decode the received bit-stream and store resulting video data in a tile-by-tile format. A pixel generation circuit of the video decoder may reconstruct pixels of the frame tile-by-tile.

There may be some additional modifications to implement tile-based video processing in H.264 or VP8. For instance, H.264 and VP8 may set a condition that a current block have access to video coding information of a block that is located to the top-right to the current block. However, with tile-based coding, for each last macroblock in a row of a tile, the top-right block may not have been encoded or decoded and therefore, the video coding information for this top-right block may be unavailable (e.g., because this top-right block has not been encoded or decoded, the video coding information for this top-right block is unknown, and hence unavailable). To address this limitation, the video encoder may force this top-right block to always be intra-mode coded so that its coding information is already known, or identify the top-right block as not available, where not available means that the top-right block is in a separate tile. As another example, the video encoder may determine the video coding information of the top-right block, and then come back and re-determine the video coding information for that block that needed the video coding information of the top-right block, which is now available.

It should be understood that in some examples the techniques may be applicable to a video encoder, but a video decoder need not necessarily perform the inverse process. For instance, because the bit-stream generated by the video encoder conforms to the H.264 or VP8 video coding standard, the video decoder may decode the video data using techniques other than the tile-based techniques described in this disclosure. Also, the video encoder need not necessarily perform the example techniques described in this disclosure. However, the video decoder may reconstruct the video data of a frame using the tile-based techniques described in this disclosure. Both the video encoder and the video decoder may perform the example operations described in this disclosure, or one of the video encoder and video decoder may perform the example operations described in this disclosure.

Also, the term “tile” should not be confused with a “macroblock” as used in the H.264 video coding standard or similar video data structure in the VP8 video coding standard. A tile includes a plurality of macroblocks. For instance, video encoding and video decoding may be performed at a macroblock level (e.g., determining prediction information, such as motion vector or intra-prediction mode etc.). Such block level determinations may not be made for each tile. Rather, for each tile there may be some constraints as to which video data is available for encoding and decoding, but there may be no motion vector or intra-prediction mode determination for a tile. Also, the size of a macroblock may be restricted to certain possible fixed sizes. The size of a tile may be more dynamic and selectable by the video encoder or some other circuit that provides information of the tile sizes to the video encoder. For example, a macroblock is a maximum size of a prediction unit. All of the predictions are processes based on macroblock or smaller macroblock. Tile is a rectangle region of a frame, and more of a sub-frame.

In the H.264 and VP8 standards, a macroblock may be further partitioned into partition blocks, and the encoding and decoding operations may occur on these partitioned blocks. However, the macroblock need not necessarily be partitioned into blocks. In this disclosure, the example techniques are described as being applied to macroblocks. However, such description should be understood to include operations that would occur on the partition blocks of the macroblocks.

For instance, a macroblock being inter-predicted or intra-predicted refers to both the scenario where macroblock is not partitioned, and to the scenario where the macroblock is partitioned into partition blocks, and the partition blocks are inter-predicted or intra-predicted. Hence, the use of the term macroblock should not be considered limited to mean only the macroblock with no partitions, but is used to also capture the partitions of the macroblocks.

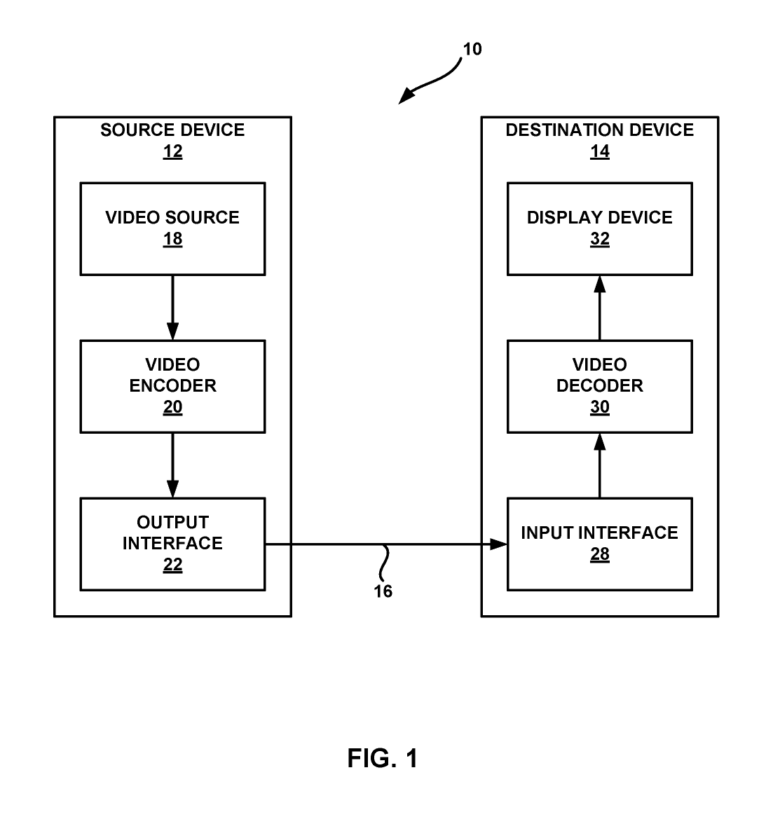

FIG. 1 is a block diagram illustrating an example video coding system 10 that may utilize the techniques of this disclosure. As used herein, the term “video coder” refers generically to both video encoders and video decoders. In this disclosure, the terms “video coding” or “coding” may refer generically to video encoding or video decoding. Video encoder 20 and video decoder 30 of video coding system 10 represent examples of devices that include circuitry for performing tile-based encoding and decoding, respectively.

As shown in FIG. 1, video coding system 10 includes a source device 12 and a destination device 14. Source device 12 generates encoded video data. Accordingly, source device 12 may be referred to as a video encoding device or a video encoding apparatus. Destination device 14 may decode the encoded video data generated by source device 12. Accordingly, destination device 14 may be referred to as a video decoding device or a video decoding apparatus. Source device 12 and destination device 14 may be examples of video coding devices or video coding apparatuses.

Source device 12 and destination device 14 may comprise a wide range of devices, including desktop computers, mobile computing devices, notebook (e.g., laptop) computers, tablet computers, set-top boxes, telephone handsets such as so-called “smart” phones, televisions, cameras, display devices, digital media players, video gaming consoles, in-car computers, or the like.

Destination device 14 may receive encoded video data from source device 12 via a channel 16. Channel 16 may comprise one or more media or devices capable of moving the encoded video data from source device 12 to destination device 14. In one example, channel 16 may comprise one or more communication media that enable source device 12 to transmit encoded video data directly to destination device 14 in real-time. In this example, source device 12 may modulate the encoded video data according to a communication standard, such as a wireless communication protocol, and may transmit the modulated video data to destination device 14. The one or more communication media may include wireless and/or wired communication media, such as a radio frequency (RF) spectrum or one or more physical transmission lines. The one or more communication media may form part of a packet-based network, such as a local area network, a wide-area network, or a global network (e.g., the Internet). The one or more communication media may include routers, switches, base stations, or other equipment that facilitate communication from source device 12 to destination device 14.

In another example, channel 16 may include a storage medium that stores encoded video data generated by source device 12. In this example, destination device 14 may access the storage medium, e.g., via disk access or card access. The storage medium may include a variety of locally-accessed data storage media such as Blu-ray discs, DVDs, CD-ROMs, flash memory, or other suitable digital storage media for storing encoded video data.

In a further example, channel 16 may include a file server or another intermediate storage device that stores encoded video data generated by source device 12. In this example, destination device 14 may access encoded video data stored at the file server or other intermediate storage device via streaming or download. The file server may be a type of server capable of storing encoded video data and transmitting the encoded video data to destination device 14. Example file servers include web servers (e.g., for a website), file transfer protocol (FTP) servers, network attached storage (NAS) devices, and local disk drives.

Destination device 14 may access the encoded video data through a standard data connection, such as an Internet connection. Example types of data connections may include wireless channels (e.g., Wi-Fi connections), wired connections (e.g., DSL, cable modem, etc.), or combinations of both that are suitable for accessing encoded video data stored on a file server. The transmission of encoded video data from the file server may be a streaming transmission, a download transmission, or a combination of both.

The techniques of this disclosure are not limited to wireless applications or settings. The techniques may be applied to video coding in support of a variety of multimedia applications, such as over-the-air television broadcasts, cable television transmissions, satellite television transmissions, streaming video transmissions, e.g., via the Internet, encoding of video data for storage on a data storage medium, decoding of video data stored on a data storage medium, or other applications. In some examples, video coding system 10 may be configured to support one-way or two-way video transmission to support applications such as video streaming, video playback, video broadcasting, and/or video telephony.

Video coding system 10 illustrated in FIG. 1 is merely an example and the techniques of this disclosure may apply to video coding settings (e.g., video encoding or video decoding) that do not necessarily include any data communication between the encoding and decoding devices. In some examples, data is retrieved from a local memory, streamed over a network, or the like. A video encoding device may encode and store data to memory, and/or a video decoding device may retrieve and decode data from memory. In many examples, the encoding and decoding is performed by devices that do not communicate with one another, but simply encode data to memory and/or retrieve and decode data from memory.

In the example of FIG. 1, source device 12 includes a video source 18, a video encoder 20, and an output interface 22. In some examples, output interface 22 may include a modulator/demodulator (modem) and/or a transmitter. Video source 18 may include a video capture device (e.g., a video camera), a video archive containing previously-captured video data, a video feed interface to receive video data from a video content provider, and/or a computer graphics system for generating video data, or a combination of such sources of video data.

Video encoder 20 may encode video data from video source 18. In some examples, source device 12 directly transmits the encoded video data to destination device 14 via output interface 22. In other examples, the encoded video data may also be stored onto a storage medium or a file server for later access by destination device 14 for decoding and/or playback.

In the example of FIG. 1, destination device 14 includes an input interface 28, a video decoder 30, and a display device 32. In some examples, input interface 28 includes a receiver and/or a modem. Input interface 28 may receive encoded video data over channel 16. Display device 32 may be integrated with or may be external to destination device 14. In general, display device 32 displays decoded video data. Display device 32 may comprise a variety of display devices, such as a liquid crystal display (LCD), a plasma display, an organic light emitting diode (OLED) display, or another type of display device.

Video encoder 20 and video decoder 30 each may be implemented as any of a variety of suitable fixed-function and/or programmable circuitry, such as one or more microprocessors, digital signal processors (DSPs), application-specific integrated circuits (ASICs), field-programmable gate arrays (FPGAs), discrete logic, hardware, or any combinations thereof. If the techniques are implemented partially in software, a device may store instructions for the software in a suitable, non-transitory computer-readable storage medium and may execute the instructions in hardware using one or more processors to perform the techniques of this disclosure. Any of the foregoing (including hardware, software, a combination of hardware and software, etc.) may be considered to be one or more processors or processing circuitry such as programmable and/or fixed-function circuitry. Each of video encoder 20 and video decoder 30 may be included in one or more encoders or decoders, either of which may be integrated as part of a combined encoder/decoder (CODEC) in a respective device.

This disclosure may generally refer to video encoder 20 “signaling” or “transmitting” certain information to another device, such as video decoder 30. The term “signaling” or “transmitting” may generally refer to the communication of syntax elements and/or other data used to decode the compressed video data. Such communication may occur in real- or near-real-time. Alternately, such communication may occur over a span of time, such as might occur when storing syntax elements to a computer-readable storage medium in an encoded bit-stream at the time of encoding, which then may be retrieved by a decoding device at any time after being stored to this medium.

In some examples, video encoder 20 and video decoder 30 operate according to a video compression standard. Examples video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions. Another example is Google's VP8 video coding standard.

In addition, a new video coding standard, namely High Efficiency Video Coding (HEVC), has recently been developed by the Joint Collaboration Team on Video Coding (JCT-VC) of ITU-T Video Coding Experts Group (VCEG) and ISO/IEC Motion Picture Experts Group (MPEG). Also, Google's VP9 video coding standard is another example video coding standard. While the above provides some examples of video coding standards, the techniques described in this disclosure are generally applicable to video coding techniques that use tiles.

In the various video coding standards, video encoder 20 determines a residual block which is the difference between a current block being encoded and a predictive block. Video encoder 20 transforms this residual block into a coefficient block, which video encoder 20 may then quantize, entropy encode, and signal. Video decoder 30 entropy decodes and inverse-quantizes to generate the coefficient block. Video decoder 30 inverse-transforms the coefficient block to generate the residual block, and adds the residual block to the predictive block to reconstruct the video block.

In the HEVC video coding standard, to generate an encoded representation of a picture, video encoder 20 may generate a set of coding tree units (CTUs). Each of the CTUs may be a coding tree block of luma samples, two corresponding coding tree blocks of chroma samples, and syntax structures used to code the samples of the coding tree blocks. A coding tree block may be an N×N block of samples. A CTU may also be referred to as a “tree block” or a “largest coding unit” (LCU). The CTUs of HEVC may be broadly analogous to the macroblocks of other standards, such as H.264/AVC. However, a CTU is not necessarily limited to a particular size and may include one or more coding units (CUs). A slice may include an integer number of CTUs ordered consecutively in the raster scan.

To generate a coded CTU, video encoder 20 may recursively perform quad-tree partitioning on the coding tree blocks of a CTU to divide the coding tree blocks into coding blocks, hence the name “coding tree units.” A coding block is an N×N block of samples. A CU may be a coding block of luma samples and two corresponding coding blocks of chroma samples of a picture that has a luma sample array, a Cb sample array and a Cr sample array, and syntax structures used to code the samples of the coding blocks. Video encoder 20 may partition a coding block of a CU into one or more prediction blocks. A prediction block may be a rectangular (i.e., square or non-square) block of samples on which the same prediction is applied. A prediction unit (PU) of a CU may be a prediction block of luma samples, two corresponding prediction blocks of chroma samples of a picture, and syntax structures used to predict the prediction block samples. Video encoder 20 may generate predictive luma, Cb and Cr blocks for luma, Cb and Cr prediction blocks of each PU of the CU.

Video encoder 20 may use intra prediction or inter prediction, as a few examples, to generate (e.g., determine) the predictive blocks for a PU. If video encoder 20 uses intra prediction to generate the predictive blocks of a PU, video encoder 20 may generate the predictive blocks of the PU based on decoded samples of the picture associated with the PU. If video encoder 20 uses inter prediction to generate (e.g., determine) the predictive blocks of a PU, video encoder 20 may generate the predictive blocks of the PU based on decoded samples of one or more pictures other than the picture associated with the PU. Video encoder 20 may use uni-prediction or bi-prediction to generate the predictive blocks of a PU. When video encoder 20 uses uni-prediction to generate the predictive blocks for a PU, the PU may have a single motion vector (MV). When video encoder 20 uses bi-prediction to generate the predictive blocks for a PU, the PU may have two MVs.

After video encoder 20 generates predictive luma, Cb and Cr blocks for one or more PUs of a CU, video encoder 20 may generate a luma residual block for the CU. Each sample in the CU's luma residual block indicates a difference between a luma sample in one of the CU's predictive luma blocks and a corresponding sample in the CU's original luma coding block. In addition, video encoder 20 may generate a Cb residual block for the CU. Each sample in the CU's Cb residual block may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may use quad-tree partitioning to decompose the luma, Cb and Cr residual blocks of a CU into one or more luma, Cb and Cr transform blocks. A transform block may be a rectangular block of samples on which the same transform is applied. A transform unit (TU) of a CU may be a transform block of luma samples, two corresponding transform blocks of chroma samples, and syntax structures used to transform the transform block samples. Thus, each TU of a CU may be associated with a luma transform block, a Cb transform block, and a Cr transform block. The luma transform block associated with the TU may be a sub-block of the CU's luma residual block. The Cb transform block may be a sub-block of the CU's Cb residual block. The Cr transform block may be a sub-block of the CU's Cr residual block.

Video encoder 20 may apply one or more transforms to a luma transform block of a TU to generate a luma coefficient block for the TU. A coefficient block may be a two-dimensional array of transform coefficients. A transform coefficient may be a scalar quantity. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the transform coefficients, providing further compression. After video encoder 20 quantizes a coefficient block, video encoder 20 may entropy encode syntax elements indicating the quantized transform coefficients. For example, video encoder 20 may perform Context-Adaptive Binary Arithmetic Coding (CABAC) on the syntax elements indicating the quantized transform coefficients. Video encoder 20 may output the entropy-encoded syntax elements in a bit-stream.

Video decoder 30 may receive a bit-stream generated by video encoder 20. In addition, video decoder 30 may parse the bit-stream to decode syntax elements from the bit-stream. Video decoder 30 may reconstruct the pictures of the video data based at least in part on the syntax elements decoded from the bit-stream. The process to reconstruct the video data may be generally reciprocal to the process performed by video encoder 20. For instance, video decoder 30 may use MVs of PUs to determine predictive blocks for the PUs of a current CU. In addition, video decoder 30 may inverse quantize transform coefficient blocks associated with TUs of the current CU. Video decoder 30 may perform inverse transforms on the transform coefficient blocks to reconstruct transform blocks associated with the TUs of the current CU.

Video decoder 30 may reconstruct the coding blocks of the current CU by adding the samples of the predictive blocks for PUs of the current CU to corresponding samples of the transform blocks of the TUs of the current CU. By reconstructing the coding blocks for each CU of a picture, video decoder 30 may reconstruct the picture.

The above describes one example way in which video encoder 20 encodes and video decoder 30 decodes video data in accordance with the HEVC video coding standard. Video encoder 20 and video decoder 30 may perform similar operations for the VP9 video coding standard.

In some examples, for video encoding, in accordance with HEVC or VP9, video encoder 20 may divide a picture into a plurality of tiles. Each tile may include a plurality of CTUs. The tiles may be evenly sized and be rectangular in shape. Each of the tiles may be individually encodable. This means that video encoder 20 may not need video data from or associated with any other tile to encode the current tile. For instance, a CTU in one tile of a current picture may not need any information from a CTU in another tile of the current picture for encoding.

One benefit of tile-based encoding is that video encoder 20 may encode tiles in parallel. As an example, rather than using one computationally powerful, and generally expensive, processing core of video encoder 20 to encode a picture in a certain amount of time, it may be possible for video encoder 20 to divide a picture into four tiles and use four processing cores, each with less computational power, to encode the picture in the same amount of time.

Another benefit of tile-based encoding is that the amount of memory space needed may be reduced. For instance, to determine a predictive block, video encoder 20 may need to fetch reference pixels from memory and store the fetched reference pixels in local cache memory. As an example, for inter-prediction, video encoder 20 may need to fetch reference pixels of a reference picture from memory. If video encoder 20 were to repeatedly retrieve all pixels of a reference picture, the external memory bandwidth and processing power may be relatively large.

One way to keep the memory bandwidth and power low may be to use a picture row cache architecture. In the picture row cache architecture, the width of a cache is the width of a row of the picture (e.g., one row of cache can store one row of pixels of a picture), but the length of the cache may be less than the length of the picture. Therefore, the amount of video data that needs to be retrieved at any given time may be limited by the size of the picture row cache. However, the size of the picture row cache may still be relatively large to support video encoding for pictures with large picture width.

With tile-based encoding, such as in HEVC and VP9, video encoder 20 may use a tile row cache instead of a picture row cache. A tile row cache is a cache with width that is smaller than the width of the picture, and with length smaller than length of the picture. The term “width” is used to indicate the number of samples the cache may store (e.g., based on the bitdepth of the samples). For instance, video encoder 20 or another circuit may determine the size of a tile (e.g., width and length), and video encoder 20 may divide the picture into a plurality of tiles based on the determined size. For a row of each tile, video encoder 20 may not need to fetch more reference pixels than the size of the row of the tile, therefore, the width of cache may be set to the size of the row of the tile, which may be smaller than the width of the picture.

While tile row cache may be available in HEVC and VP9, other video coding standards such as H.264 and VP8 may not support tile row cache, and instead rely on frame row cache. One reason that tile row cache is available in HEVC and VP9 is that the bit-stream generation is performed on a per-tile basis. However, in H.264 and VP8, to conform the bit-stream to the H.264 or VP8 (as applicable), the bit-stream is generated row-by-row. Another potential reason why tile row cache may be unavailable for H.264 and VP8 is that in H.264 and VP8 certain pixels outside of a tile may be used for encoding/decoding pixels in the tile. However, due to the independent encodability and decodability, pixels from outside the tile may not need to be available for encoding/decoding pixels in the tile.

This disclosure describes example techniques to utilize tile row caches in H.264 and VP8 while still conforming to the requirements of H.264 and VP8. For instance, video encoder 20 may generate tile-based video data that is stored in a plurality of buffers, and may read the tile-based video data from the buffers in a way that reads video data of one entire row of a frame before reading video data of another row of the frame. In addition, video encoder 20 may set conditions on how certain pixels of a tile can be encoded so as to avoid the necessity to read pixels values for pixels outside the tile (or may read the pixel values for pixels outside the tile in a second pass for optimization).

The above provided some context for encoding in HEVC and VP9. The following provides information or encoding in H.264 and VP8.

In H.264, rather than CTUs, CUs, and PUs, video encoder 20 and video decoder 30 operate on macroblocks. For example, video encoder 20 operates on macroblocks of pixels within individual video frames in order to encode the video data. The video macroblocks may have fixed or varying sizes. Each video frame includes a series of slices. Each slice may include a series of macroblocks, which may be arranged into sub-blocks (also called partition blocks). Slices and tiles should not be confused. For instance, slices may be available in H.264, but tile based encoding may not have been available.

Tile is rectangular region and divides one frame while keeping the spatial correlation, which is efficient for encoding. A slice may similarly divide a frame. However, in the case of slice, one frame may be cut into many slices since it cannot be divided with rectangle shape. Instead of tile, many slices may be required to divide one frame row into slices. It will cause encoding quality loss due to the following reasons. At the start of slice, a slice header is needed and consumes some bits at the start of slice. 2. Also, blocks outside of the current slice cannot be used as predictor.

Another option for slice is FMO (Flexible Macroblock Ordering) to make the macroblock order into TILE order. But FMO is only allowed in baseline and extended profiles. For large frame video, like 4 k or 8 k, high profile should be used, and cannot use FMO.

In general, slices require encoding overhead to provide information about the macroblocks within the slices. Tiles may not require such overhead, and may not include information about the macroblocks within the tiles such as how the macroblocks are encoded. Tiles and slices are understood as different video coding objects, and the techniques described in this disclosure utilize tiles in this manner, and different from slices.

As an example, the ITU-T H.264 standard supports intra prediction in various macroblock sizes, such as 16 by 16, 8 by 8, 4 by 4 for luma components, and 8 by 8 for chroma components. H.264 also supports as inter prediction in various macroblock sizes, such as 16 by 16, 16 by 8, 8 by 16, 8 by 8, 8 by 4, 4 by 8 and 4 by 4 for luma components and corresponding scaled sizes for chroma components.

Smaller video blocks can provide better resolution, and may be used for locations of a video frame that include higher levels of detail. In general, macroblocks (MBs) and the various sub-blocks may be considered to be video blocks. In addition, a slice may be considered to be a series of video blocks, such as MBs and/or sub-blocks. Each slice may be an independently decodable unit. After prediction, video encoder 20 applies a transform to the 8 by 8 residual block or 4 by 4 residual block. An additional transform may be applied to the DC coefficients of the 4 by 4 blocks for chroma components or luma component if the intra 16×16 prediction mode is used.

For purposes of illustration, this disclosure describes the example techniques as being performed by on macroblocks. However, such description covers the cases where a macroblock is partitioned into smaller sub-blocks (or partition blocks).

Generally, video encoder 20 applies a discrete cosine transform (DCT) to the blocks, generating DCT coefficients, also referred to as transform coefficients, or more generally as digital video block coefficients. The DCT generates DCT coefficients that are generally ordered such that the resulting DCT coefficients having non-zero values are grouped together and those having zero values are grouped together. Video encoder 20 then performs a form of serialization that involves scanning the resulting DCT coefficients in accordance with a particular scanning order or pattern. A zig-zag scan is one example, although different scanning patterns may be employed so as to extract the groups of zero and non-zero DCT coefficients, such as vertical, horizontal or other scanning patterns. Once extracted, video encoder 20 performs what is commonly referred to as “run-length coding,” which typically involves computing a total number of zero DCT coefficients (i.e., the so-called “run”) that are contiguous (i.e. adjacent to one another) after being serialized.

Next, video encoder 20 performs statistical lossless coding, which is commonly referred to as entropy encoding. Entropy encoding is a lossless process used to further reduce the number of bits that need to be transmitted from source device 12 to receive device 14 in order for receive device 14 to reconstruct the set of DCT coefficients. Examples of the entropy encoding include the CABAC, described above, context adaptive variable length coding (CAVLC) as another example technique used in H.264.

Video decoder 30 may perform the inverse of the process of video encoder 20 to decode and reconstruct a macroblock in accordance with the H.264 standard. Video encoder 20 and video decoder 30 may perform similar operations in accordance with the VP8 standard.

In the example techniques described in this disclosure, for using the tile row cache, while conforming to the H.264 or VP8 standards, video encoder 20 may generate residual data for macroblocks for a plurality of tiles of a current frame. Each tile includes a plurality of macroblocks, and each tile is independently encoded from the other tiles of the current frame. A width of each tile is less than a width of the current frame. In generating the residual data, video encoder 20 may retrieve reference pixel values for storage in a cache (e.g., tile row cache where a width of the cache is equal to a width of a tile and less than a width of the current frame). In one example, video encoder 20 may generate residual data for macroblocks of a tile in raster scan order, but other scan orders are possible.

Video encoder 20 may store the residual data in a plurality of buffers. Each buffer is associated with one or more tiles, and each buffer is configured to store residual data for macroblocks for the one or more tiles with which each buffer is associated (e.g., a first buffer stores residual data for macroblocks of a first tile, a second buffer stores residual data for macroblocks of a second tile, and so forth). Each buffer may also store motion vector differences (MVDs), intra mode information, macroblock type, quantization parameters, and other such information needed to encode or decode the macroblock such as in an entropy encoder or decoder. Video encoder 20 may store the residual data of macroblocks of a tile in a buffer in potentially in the same order in which it generated the residual data (e.g., store the residual data of macroblocks of a tile in raster order in the buffer associated with the tile).

In examples described in this disclosure, video encoder 20 may read residual data from different buffers for macroblocks of an entire row of the current frame before reading residual data from different buffers for macroblocks of any other row of the current frame. As an example, rather than reading residual data tile-by-tile, video encoder 20 may read residual data from a first buffer that corresponds to macroblocks of a first row of the current frame, then instead of reading the next row of the buffer, video encoder 20 may read residual data from a second buffer that corresponds to macroblocks of the first row of the current frame, and so forth until video encoder 20 reads the residual data for an entire row of the current frame.

To encode the residual data, video encoder 20 may entropy encode the residual data based on the read residual data. Because the residual data is read row-by-row for the current frame, video encoder 20 may entropy encode the residual data row-by-row. Video encoder 20 may then proceed to the next frame.

Video decoder 30 may perform the inverse of these example operations of video encoder 20. For example, video decoder 30 may entropy decode residual data from the bit-stream for macroblocks of an entire row of a current frame before entropy decoding residual data from macroblocks of any other rows of the current frame.

Video decoder 30 may store the residual data in plurality of buffers. For instance, video decoder 30 may store residual data for a first subset of a row of macroblocks in a first buffer, store residual data for a second subset of the row of macroblocks in a second buffer, and so forth. In general, each buffer is associated with one or more tiles, and each buffer is configured to store residual data for macroblocks for the one or more tiles with which each buffer is associated. Each buffer may also store motion vector differences (MVDs), intra mode information, macroblock type, quantization parameters, and other such information needed to encode or decode the macroblock such as in an entropy encoder or decoder. Video decoder 30 may then reconstruct the macroblocks based on the residual data stored in the buffers. Video decoder 30 may reconstruct the macroblocks on a tile-by-tile basis by retrieving reference pixel values for storage in a cache (e.g., where a width of the cache is equal to a width of a tile and less than a width of the current frame). Video decoder 30 may add the residual data with the reference pixel values to reconstruct the macroblocks.

In this way, video encoder 20 and video decoder 30 may utilize tile row caches, while still conforming to the requirements of H.264 or VP8. For instance, the techniques described in this disclosure allow for tile-based encoding but generate bit-stream row-by-row. Such row-by-row bit-stream generation may be a requirement of H.264 or VP8, and the techniques described in this disclosure may be extendable to other video coding techniques where row-by-row bit-stream generation is utilized.

Also, in the above example, the term “residual data” is meant to convey one of a few possibilities. Residual data may be difference between the macroblocks of the current frame and respective predictive frames, coefficient values generated from applying a transform to the difference between the macroblocks of the current frame and respective predictive frames, or quantized coefficient value generated from applying quantization to the coefficient values generated from applying a transform to the difference between the macroblocks of the current frame and respective predictive frames.

For example, video encoder 20 may generate a difference between pixels of macroblocks and reference pixels, and if transform and quantization are skipped, store the difference values as residual data. As another example, if transform is applied, but quantization is skipped, video encoder 20 may transform the values generated from the difference, and store the transformed values as residual data. As yet another example, if quantization is applied, video encoder 20 may quantize the values generated from the transform, and store the quantized values as residual data. In these examples, more generally, video encoder 20 may generate the residual data based on the determined difference between reference pixel values and pixel values of macroblocks.

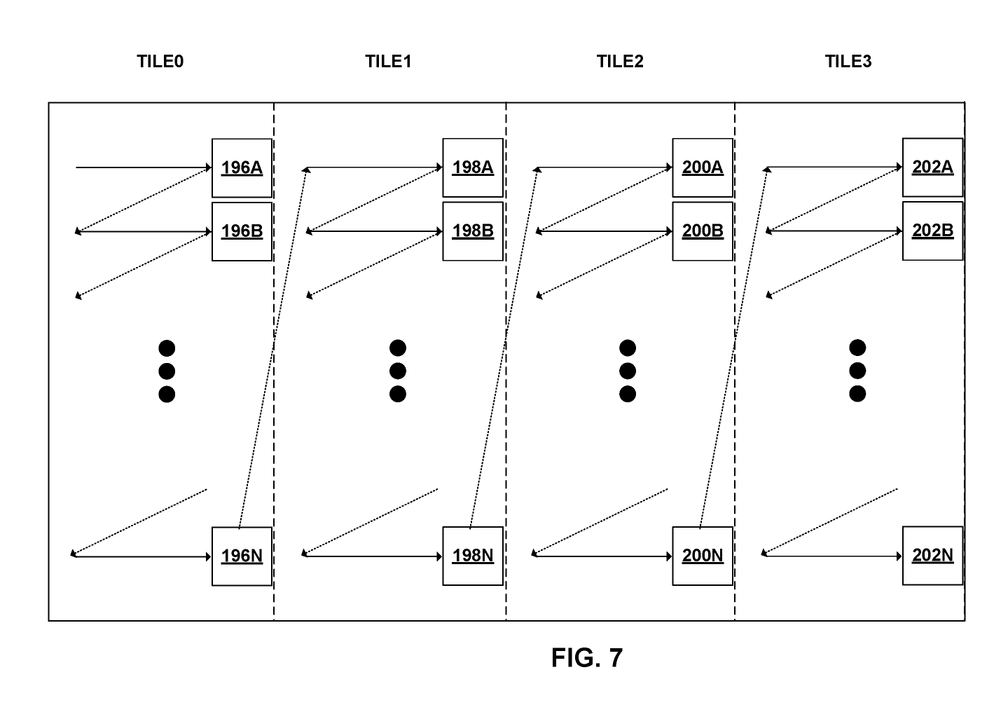

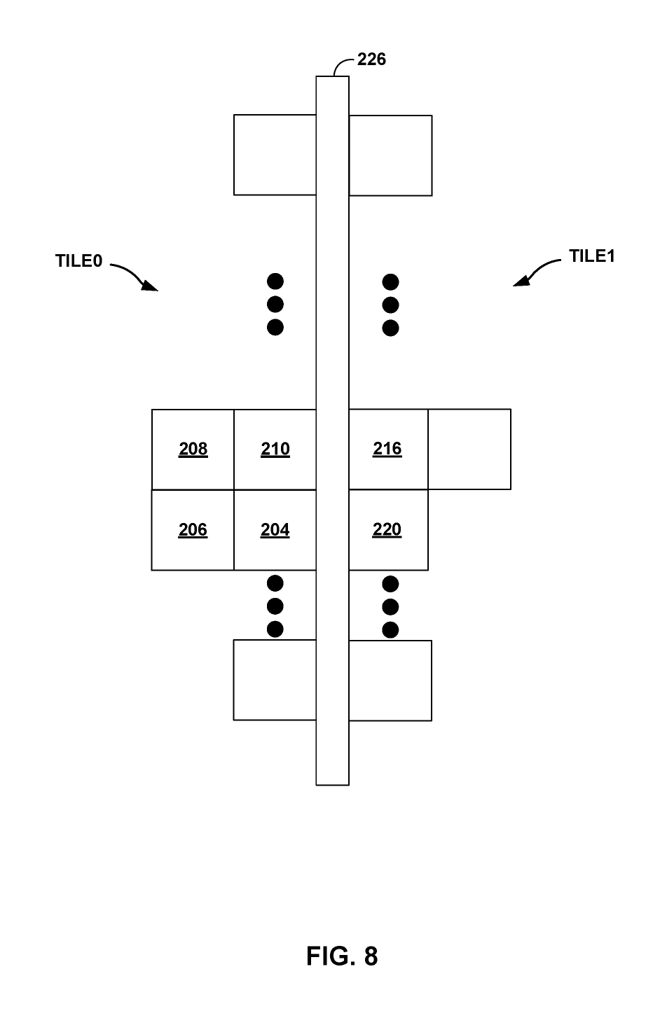

Video encoder 20 and video decoder 30 may perform additional optimizations on the encoding/decoding to allow for tile-based encoding/decoding where pixel values outside of the tile are not needed. These examples are described in more detail with respect to FIGS. 7 and 8.

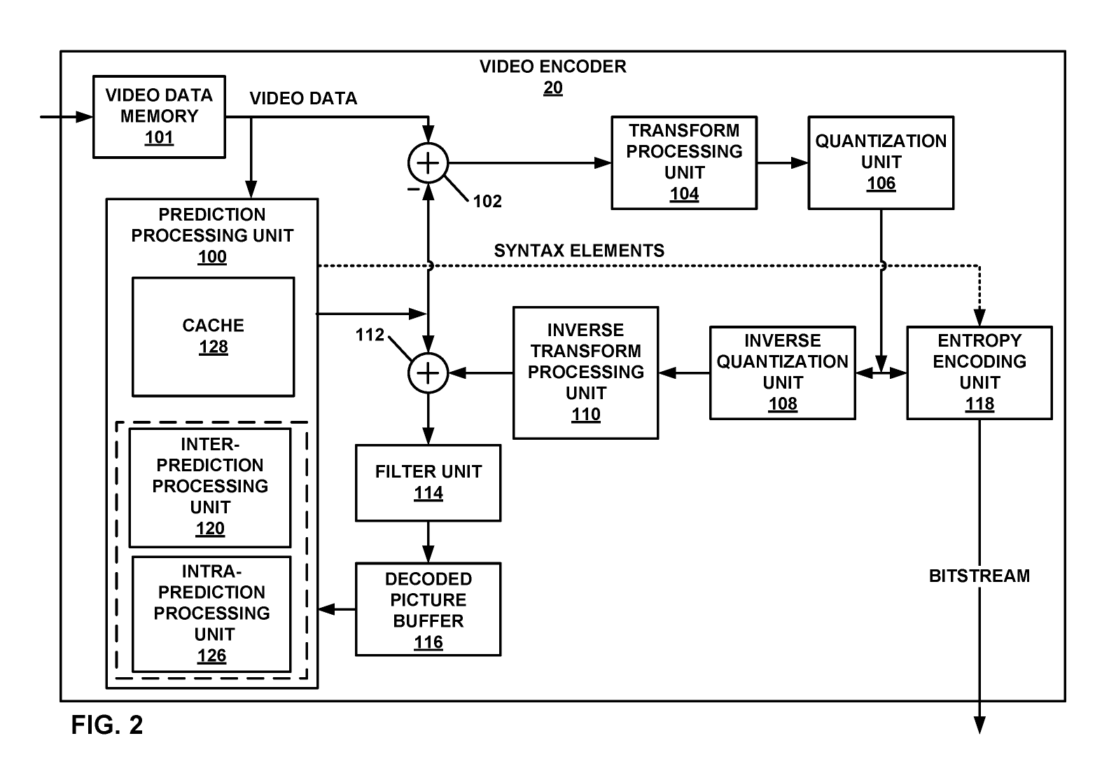

FIG. 2 is a block diagram illustrating an example video encoder 20 that may implement the techniques of this disclosure. FIG. 2 is provided for purposes of explanation and should not be considered limiting of the techniques as broadly exemplified and described in this disclosure.

Processing circuitry includes video encoder 20, and video encoder 20 is configured to perform one or more of the example techniques described in this disclosure. For instance, video encoder 20 includes integrated circuitry, and the various units illustrated in FIG. 2 may be formed as hardware circuit blocks that are interconnected with a circuit bus. These hardware circuit blocks may be separate circuit blocks or two or more of the units may be combined into a common hardware circuit block. The hardware circuit blocks may be formed as combination of electric components that form operation blocks such as arithmetic logic units (ALUs), elementary function units (EFUs), as well as logic blocks such as AND, OR, NAND, NOR, XOR, XNOR, and other similar logic blocks.

In some examples, one or more of the units illustrated in FIG. 2 may be software units executing on the processing circuitry. In such examples, the object code for these software units is stored in memory. An operating system may cause video encoder 20 to retrieve the object code and execute the object code, which causes video encoder 20 to perform operations to implement the example techniques. In some examples, the software units may be firmware that video encoder 20 executes at startup. Accordingly, video encoder 20 is a structural component having hardware that performs the example techniques and/or has software/firmware executing on the hardware to specialize the hardware to perform the example techniques.

In the example of FIG. 2, video encoder 20 includes a prediction processing unit 100, video data memory 101, a residual generation unit 102, a transform processing unit 104, a quantization unit 106, an inverse quantization unit 108, an inverse transform processing unit 110, a reconstruction unit 112, a filter unit 114, a decoded picture buffer 116, and an entropy encoding unit 118. Prediction processing unit 100 includes an inter-prediction processing unit 120 and an intra-prediction processing unit 126. Inter-prediction processing unit 120 includes a motion estimation unit and a motion compensation unit (not shown). In other examples, video encoder 20 may include more, fewer, or different functional components.

Video data memory 101 may store video data to be encoded by the components of video encoder 20. The video data stored in video data memory 101 may be obtained, for example, from video source 18. Decoded picture buffer 116 may be a reference picture memory that stores reference video data for use in encoding video data by video encoder 20 (e.g., in intra- or inter-coding modes). Video data memory 101 and decoded picture buffer 116 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 101 and decoded picture buffer 116 may be provided by the same memory device or separate memory devices. In various examples, video data memory 101 may be on-chip with other components of video encoder 20, or off-chip relative to those components.

Inter-prediction processing unit 120 compares video block to blocks in one or more adjacent video frames to generate one or more motion vectors. The adjacent frame or frames may be retrieved from decoded picture buffer (DPB) 116, which may include any type of memory or data storage device to store video blocks reconstructed from previously encoded blocks. Motion estimation may be performed for blocks of variable sizes, e.g., 32 by 32, 32 by 16, 16 by 32, 16 by 16, 16 by 8, 8 by 16, 8 by 8 or smaller block sizes. Inter-prediction processing unit 120 identifies one or more blocks in adjacent frames that most closely matches the current video block, e.g., based on a rate distortion model, and determines displacement between the blocks in adjacent frames and the current video block. On this basis, inter-prediction processing unit 120 produces one or more motion vectors (MV) that indicate the magnitude and trajectory of the displacement between current video block and one or more matching blocks from the reference frames used to encode the current video block.

Motion vectors may have half- or quarter-pixel precision, or even finer precision, allowing video encoder 20 to track motion with higher precision than integer pixel locations and obtain a better prediction block. When motion vectors with fractional pixel values are used, interpolation operations are carried out in inter-prediction processing unit 120. Inter-prediction processing unit identifies the best block partitions and motion vector or motion vectors for a video block using certain criteria, such as a rate-distortion model. For example, there may be more than motion vector in the case of bi-directional prediction. Using the resulting block partitions and motion vectors, inter-prediction processing unit forms a prediction video block.

Intra-prediction processing unit 126 may generate a prediction video block for the current block by performing intra prediction on the block. To perform intra prediction, intra-prediction processing unit 126 may use multiple intra prediction modes to generate multiple sets of predictive data for the current block. Intra-prediction processing unit 126 may use samples from sample blocks of neighboring blocks to generate a prediction video block for a current block. The neighboring blocks may be above, above and to the right, above and to the left, or to the left of the current block, assuming a left-to-right, top-to-bottom encoding order. Intra-prediction processing unit 126 may use various numbers of intra prediction modes.

Prediction processing unit 100 may select the prediction video block from among the prediction video blocks generated by inter-prediction processing unit 120 and generated by intra-prediction processing unit 126. In some examples, prediction processing unit 100 selects the prediction video block based on rate/distortion metrics. The prediction video blocks of the selected prediction video block may be referred to herein as the selected prediction video blocks or prediction blocks. The prediction blocks include reference pixel values that are used for encoding the current block.

Video encoder 20 forms a residual video block by subtracting the prediction video block produced by inter-prediction processing unit 120 from the original, current video block at residual generation unit 102. Transform processing unit 104 applies a transform, such as the 4 by 4 or 8 by 8 to the residual block, producing residual transform block coefficients. Quantization unit 106 quantizes the residual transform block coefficients to further reduce bit rate.

Entropy encoding unit 118 entropy encodes the quantized coefficients to even further reduce bit rate. Entropy encoding unit 118 functions as a VLC encoding unit, context adaptive binary arithmetic coding (CABAC) encoding unit, content adaptive variable length coding (CAVLC) encoding unit, or Golomb encoding unit. For VP8, entropy encoding unit 118 may be a Bool encoding unit, which is another example of an arithmetic coder.

Inverse quantization unit 108 and inverse transform processing unit 110 apply inverse quantization and inverse transformation, respectively, to reconstruct the residual block. Reconstruction unit 112 adds the reconstructed residual block to the prediction block to produce a reconstructed video block for storage in DPB 116 (e.g., after operations of filter unit 114 or directly storing where filtering from filter unit 114 is not needed). The reconstructed video block is used by inter-prediction processing unit 120 or intra-prediction processing unit 126 to encode a block in a subsequent video frame.

Filter unit 114 may perform one or more deblocking operations to reduce blocking artifacts. Decoded picture buffer 116 may store the reconstructed blocks after filter unit 114 performs the one or more deblocking operations on the reconstructed coding blocks.

In the example techniques described in this disclosure, inter-prediction processing unit 120 or intra-prediction processing unit 126 may retrieve reference pixel values from DPB 116 to form the prediction video block or predictive block. In the examples described in this disclosure, prediction processing unit 100 may include cache 128, and the width of the cache may be the width of a tile (e.g., pixel values for one row of a tile may be stored in one row of the cache). For instance, prediction processing unit 100 may divide a frame into a plurality of tiles, and inter-prediction processing unit 120 and intra-prediction processing unit 126 may perform operations on macroblocks of the tiles.

In some examples, cache 128 and DPB 116 may be in separate memories. For example, DPB 116 may be in double data rate (DDR) RAM, and cache 128 may be within prediction processing unit 100. More generally, prediction processing unit 100 may utilize a memory bus to retrieve data from DPB 116, where this memory bus is also a bus for other components external to video encoder 20. However, prediction processing unit 100 may not need such a bus that is external to video encoder 20 to access cache 128.

Inter-prediction processing unit 120 may determine a prediction block (e.g., predictive video block) for a current block. Prediction processing unit 100 may retrieve pixel values for the prediction block from DPB 116 and store the prediction block in cache 128. However, cache 128 may store more pixel values than the pixel values for just the prediction block needed for the current block. For instance, as inter-prediction processing unit 120 is inter-predicting macroblocks across a row, prediction processing unit 100 may store the pixel values for the prediction blocks for each of the macroblocks across the row, as there is a high likelihood that those same pixel values may be needed again for the next macroblock. Then, after completion of one row of macroblocks for a tile, inter-prediction processing unit 120 may begin on the next row. However, rather than clearing the values stored in cache 128, the values for the row may remain.

Accordingly, cache 128 may store pixel values for prediction blocks for macroblocks of a current row of a tile, and for macroblocks of a previous row of the tile. Prediction processing unit 100 may remove pixel values for prediction blocks for macroblocks prior to the previous row of the tile. It should be understood that cache 128 storing pixel values for prediction blocks of macroblocks for the current row and previous row of a tile is provided as one example. In other examples, cache 128 may store pixel values for prediction blocks of macroblocks in more rows than the current row and the previous row, or just those of the current row.

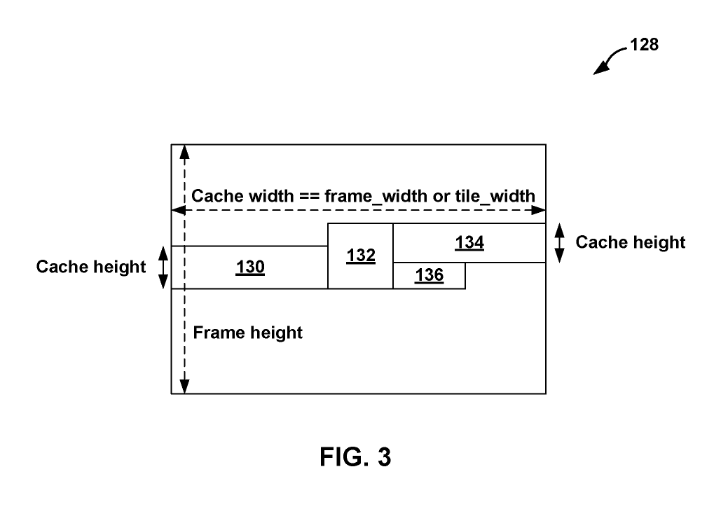

FIG. 3 is a conceptual diagram illustrating an example cache 128 storing video data. For instance, FIG. 3 illustrates an example of pixel values that would be stored in cache 128 superimposed on a frame to provide context. For example, FIG. 3 illustrates a frame height which is an example of a height of a frame. Within the fame height is illustrated a cache height. The cache height designations on opposite sides of the hypothetical frame are used to illustrate that the cache height stores pixel values for two rows of macroblocks. It should be understood that the frame illustrated in the FIG. 3 is a hypothetical frame to visually provide relative sizes. The hypothetical frame does not refer to an actual frame being encoded.

FIG. 3 also illustrates the cache width as two different possible values: the frame width or the tile width. In some existing techniques, the width of cache 128 is the frame width. However, in the techniques described in this disclosure, because tile based encoding is enabled even for standards such as H.264 and VP8, the width of cache 128 need not be the same as the frame width, and instead can be the same size as that of the tile. Because the width of the tile is less than the width of the frame, cache 128 may be smaller than other caches that are the width of the frame.

In FIG. 3, area 132 within cache 128 is an example search area for a current block of a current frame. Area 132 illustrates where pixel values for the predictive block to the current block that is being encoded are stored in cache 128. As described above, cache 128 may also store the pixel values for the predictive blocks used for macroblocks in the same row before the current block. For instance, area 130 within cache 128 is an example of pixel values that were prefetched from DPB 116 earlier. These values may remain in cache 128 for the next row of macroblocks of the current frame that are to be encoded.

Area 134 within cache 128 is an example of pixel values that were prefetched for use for the current row of macroblocks. For instance, the pixel values in area 134 may have been previously from DPB 116 during the encoding of the previous row of macroblocks, and the pixel values that were fetched during this time may remain in cache 128. Area 136 represents the area used for storing the pixel values for the predictive block for the next block in the row after the current macroblock.

In this example, the total amount of video data that needs to retrieved from DPB 116 may not change (e.g., to encode a full frame, and full frame of pixel values for predictive blocks would be needed). However, the size of cache 128 is smaller as compared to other caches that store a full row of a frame.

In some examples, cache 128 may be quarter or eighth of the size of other caches that store a full row of a frame. For example, where eight tiles are used for 8K width pictures, the size of cache 128 may be quarter or eighth leading to much smaller sized caches, and savings in reduction of costs.

Storage of two rows of macroblocks is not necessary in all examples. In the example, the storage may depend upon vertical motion vector search range. The size is: (cache height)×(frame or tile width)+(vertical search range−cache height)×(horizontal search range)×2. It is smaller than (vertical search range)×(frame or tile width).

As an example, assume the macroblock height and width is 16, the vertical search range is ±12 (e.g., 24), and the horizontal search range is ±12 (e.g., 24). Accordingly, the search range is current macroblock plus four pixels around, and the cache height is 8. In this example, area 136 i× a 20×16 rectangle. Cache is crossing two rows of macroblocks, but stores less than two rows of macroblocks. In this example, it is less than one row of macroblock. The larger the search area means the larger the cache size that may be needed.

Referring back to FIG. 2, as described, quantization unit 106 may generate residual data (e.g., quantized, transformed differences between macroblocks and predictive blocks). For instance, inter-prediction processing unit 120 may determine residual values tile-by-tile. Therefore, the residual data that quantization unit 106 generates may be generated on a tile-by-tile basis.

However, for conformance with the H.264 or VP8 standards, the bit-stream that entropy encoding unit 118 generates should not be tile-based, but rather row-based. Accordingly, the residual data generated for tiles may need to read out row-by-row.

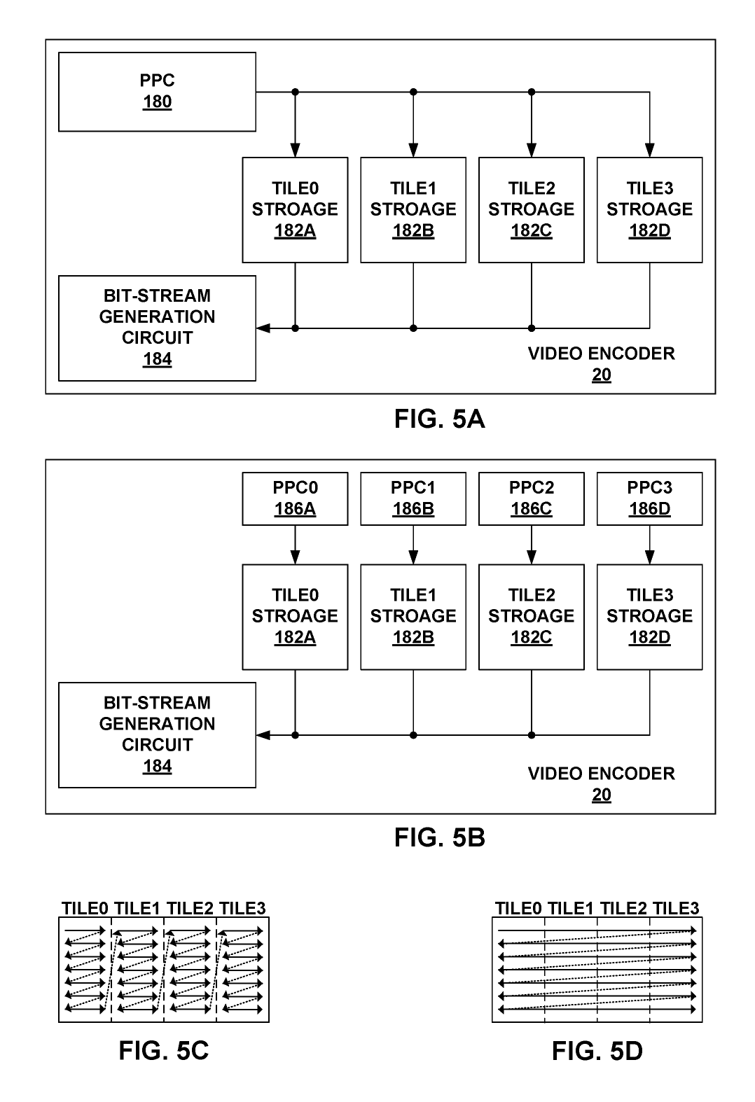

In one example, quantization unit 106 may store residual data for each tile in separate buffers (not shown in FIG. 2, but shown in FIG. 5). Each buffer may also store motion vector differences (MVDs), intra mode information, macroblock type, quantization parameters, and other such information needed to encode or decode the macroblock such as in an entropy encoder or decoder. Entropy encoding unit 118 may then the residual data row-wise from the buffers. For instance, entropy encoding unit 118 may read and entropy encode residual data stored in a first buffer for a first tile that corresponds to a first row of the current frame. Because the first tile is less than the size of the width of the entire frame, entropy encoding unit 118 may read and entropy encode residual data stored in a second buffer for a second tile that corresponds to the first row of the current frame. Entropy encoding unit 118 may repeat these operations until entropy encoding unit 118 reaches the end of the row, and may then repeat these operations starting from the next row.

In this way, quantization unit 106 may generate residual data for macroblocks for a plurality of tiles of a current frame. It should be understood that in examples where quantization unit 106 is not used or not included, the residual data may be that generated from transform processing unit 104, and in examples where transform is skipped or not included, the residual data may be the output of residual generation unit 102. For ease, the description is described with respect to quantization unit 106 generating the residual data, but the techniques are not so limited. Also, even in examples where quantization unit 106 is enabled, the residual data may still be considered to be the output of transform processing unit 104, and even in examples where transform processing unit 104 is enabled, the residual data may be considered to be the output of residual generation unit 102.

Quantization unit 106 may store the residual data in a plurality of buffers. For instance, each buffer is associated with one or more tiles. Also, each buffer is configured to store residual data for macroblocks for the one or more tiles with which each buffer is associated. As an example, each buffer may be associated with a single tile (e.g., first buffer associated with first tile, second buffer associated with second tile, and so forth). In this example, quantization unit 106 may store residual data for macroblocks of the first tile in the first buffer, store residual data for macroblocks of the second tile in the second buffer, and so forth. Each buffer may also store motion vector differences (MVDs), intra mode information, macroblock type, quantization parameters, and other such information needed to encode or decode the macroblock such as in an entropy encoder or decoder.

Entropy encoding unit 118 may read residual data from the different buffers for macroblocks of an entire row of the current frame before reading residual data from different buffers for macroblocks of any other row of the current frame. Entropy encoding unit 118 may entropy encode values based on the read residual data.

H.264 and VP8 may generate the bit-stream based on a raster scan of residual data of macroblocks across an entire row of the current frame. However, each buffer may store residual data for macroblocks for only a portion of the row. Accordingly, entropy encoding unit 118 may read across the different buffers, rather than read the residual data from one entire buffer, to generate a bit-stream that conforms to the H.264 or VP8 standards.

In some examples, to generate the residual data, prediction processing unit 100 may retrieve pixel values for storage in cache 128, where a width of cache 128 is equal to a width of a tile and less than a width of the entire frame. Residual generation unit 102 may determine a difference between pixel values of macroblocks in the tiles and the pixel values stored in cache 128. Residual generation unit 102, transform processing unit 104, or quantization unit 106 may determine the residual data based on the determined difference.

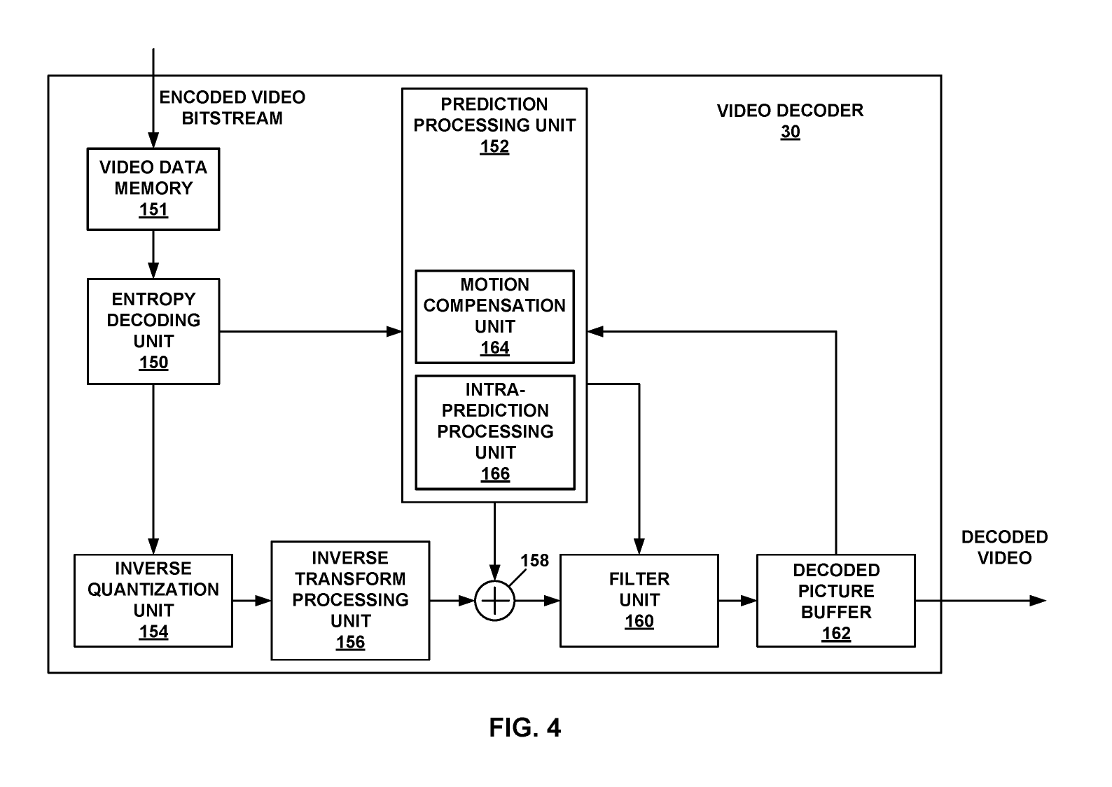

FIG. 4 is a block diagram illustrating an example video decoder 30 that is configured to implement the techniques of this disclosure. FIG. 4 is provided for purposes of explanation and is not limiting on the techniques as broadly exemplified and described in this disclosure.

Processing circuitry includes video decoder 30, and video decoder 30 is configured to perform one or more of the example techniques described in this disclosure. For instance, video decoder 30 includes integrated circuitry, and the various units illustrated in FIG. 4 may be formed as hardware circuit blocks that are interconnected with a circuit bus. These hardware circuit blocks may be separate circuit blocks or two or more of the units may be combined into a common hardware circuit block. The hardware circuit blocks may be formed as combination of electric components that form operation blocks such as arithmetic logic units (ALUs), elementary function units (EFUs), as well as logic blocks such as AND, OR, NAND, NOR, XOR, XNOR, and other similar logic blocks.

In some examples, one or more of the units illustrated in FIG. 3 may be software units executing on the processing circuitry. In such examples, the object code for these software units is stored in memory. An operating system may cause video decoder 30 to retrieve the object code and execute the object code, which causes video decoder 30 to perform operations to implement the example techniques. In some examples, the software units may be firmware that video decoder 30 executes at startup. Accordingly, video decoder 30 is a structural component having hardware that performs the example techniques and/or has software/firmware executing on the hardware to specialize the hardware to perform the example techniques.

In the example of FIG. 4, video decoder 30 includes an entropy decoding unit 150, video data memory 151, a prediction processing unit 152, an inverse quantization unit 154, an inverse transform processing unit 156, a reconstruction unit 158, a filter unit 160, and a decoded picture buffer 162. Prediction processing unit 152 includes a motion compensation unit 164 and an intra-prediction processing unit 166. In other examples, video decoder 30 may include more, fewer, or different functional components.

Video data memory 151 may store video data, such as an encoded video bit-stream, to be decoded by the components of video decoder 30. The video data stored in video data memory 151 may be obtained, for example, from computer-readable medium 16 (FIG. 1) (e.g., from a local video source, such as a camera, via wired or wireless network communication of video data, or by accessing physical data storage media). Video data memory 151 may form a coded picture buffer (CPB) that stores encoded video data from an encoded video bit-stream. Decoded picture buffer 162 may be a reference picture memory that stores reference video data for use in decoding video data by video decoder 30, e.g., in intra- or inter-coding modes. Video data memory 151 and decoded picture buffer 162 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 151 and decoded picture buffer 162 may be provided by the same memory device or separate memory devices. In various examples, video data memory 151 may be on-chip with other components of video decoder 30, or off-chip relative to those components.

Entropy decoding unit 150 receives the encoded video bit-stream and decodes from the bit-stream quantized residual coefficients, macroblock coding mode and motion information, which may include motion vectors and block partitions in the example of inter-prediction, and intra prediction modes in the example of intra-prediction. Hence, entropy decoding unit 150 functions as a VLC decoding unit, context adaptive binary arithmetic coding (CABAC) decoding unit, content adaptive variable length coding (CAVLC) decoding unit, or Golomb decoding unit. For VP8, entropy decoding unit 150 may be a Bool decoding unit, which is another example of an arithmetic coder. For example, in order to decode quantized residual coefficients from the encoded bit-stream, entropy decoding unit 150 of FIG. 4 may be configured to implement aspects of this disclosure described above with respect to FIG. 2. However, entropy decoding unit 150 performs decoding in a substantially inverse manner relative to entropy encoding unit 118 of FIG. 2 in order to retrieve quantized block coefficients from the encoded bit-stream.

In examples of intra-prediction, intra-prediction processing 166 may generate a predictive block based on the intra-prediction mode. Motion compensation unit 164 receives the motion vectors and block partitions and one or more reconstructed reference frames from decoded picture buffer (DPB) 162 to produce a prediction video block. Inverse quantization unit 154 inverse quantizes, i.e., de-quantizes, the quantized block coefficients. Inverse transform processing unit 156 applies an inverse transform, e.g., an inverse DCT or an inverse 4 by 4 or 8 by 8 integer transform, to the coefficients to produce residual blocks. The prediction video blocks (e.g., predictive blocks) are then summed by reconstruction unit 158 with the residual blocks to form decoded blocks. For intra-prediction, reconstruction unit 158 may sum the residual block with the predictive block generated by intra-prediction processing unit 166. Filter unit 160 may be applied to filter the decoded blocks to remove blocking artifacts. The filtered blocks are then placed in DPB 162, which provides reference frame for decoding of subsequent video frames and also produces decoded video to drive display device 32 (FIG. 1).

In some examples, video decoder 30 may be configured to perform tile-based decoding. For example, entropy decoding unit 150 may store the decoded values into different buffers by storing across rows of the buffers (e.g., store decoded values into a first row of a first buffer, and then a first row of a second buffer, and so forth). Inverse quantization unit 154 may inverse quantize based on the decoded values stored in each buffer rather than decode the values across the different buffers to being the decoding on a tile-by-tile basis. Inverse transform processing unit 156 may then inverse transform values for each of the tiles. In examples where inverse quantization unit 154 is not needed, inverse transform processing unit 156 may read values from the buffers, and where inverse transform processing unit 156 is not needed, reconstruction unit 158 may read values from the buffers.

FIGS. 5A-5D illustrate examples for utilizing the tile based encoding, and are described together. For ease of description, FIGS. 5A-5D describe a frame being divided into four tiles, but more or fewer tiles are possible. FIG. 5A is a block diagram illustrating an example of generating tile-based video data for video encoding, FIG. 5B is a block diagram illustrating another example of generating tile-based video data for video encoding, FIG. 5C is a conceptual diagram illustrating storage of video data in tile-by-tile format for video encoding, and FIG. 5D is a conceptual diagram illustrating reading of video data stored in tile-by-tile format for video encoding.

Prediction processing unit 100 (or some other unit) may divide a frame into a plurality of tiles. FIG. 5C illustrates an example where a frame is divided into four tiles: tile0, tile1, tile2, and tile3. Pixel processing circuit (PPC) 180 may configured to process the pixels in each of the tiles. PPC 180 of FIG. 5A is an example circuit that includes various components of video encoder 20. As an example, PPC 180 includes the units of video encoder 20 for generating the residual data such as prediction processing unit 100, residual generation unit 102, transform processing unit 104, quantization unit 106, inverse quantization unit 108, inverse transform processing unit 110, reconstruction unit 112, filter unit 114, and DPB 116 (all of FIG. 2). PPC 180 may include more or fewer components.

PPC 180 may output the residual data in respective ones of storage buffers identified as tile0 storage 182A-tile3 storage 182D. Tile0 storage 182A-tile3 storage 182D may be external to video encoder 20 or internal to video encoder 20 (e.g., part of video data memory 101). Each of tile0 storage 182A-tile-3 storage 182D may be associated with respective tiles0-tiles3. For instance, PPC 180 may store residual data for tile0 into tile0 storage 182A, store residual data for tile1 into tile1 storage 182B, store residual data for tile2 into tile2 storage 182C, and store residual data for tile3 into tile3 storage 182D. In the example illustrated in FIG. 5A, PPC 180 may generate the residual data in sequential order (e.g., first for tile0, then tile1, then tile2, and then tile3).

Bit-stream generation circuit 184 is an example of entropy encoding unit 118 (FIG. 2). In this example, bit-stream generation circuit 184 may read residual data from tile0 storage 182A-tile3 storage 182D in the order illustrated in FIG. 5D. For instance, entropy encoding unit 118 (FIG. 2) may read residual data that corresponds to macroblocks of a first row of the frame from tile0 storage 182A, then rather than read residual data for the rest of tile0 storage 182A, entropy encoding unit 118 may read residual data that corresponds to macroblocks of the first row of the frame from tile1 storage 182B, and so forth until the end of tile3 storage 182D, at which point, bit-stream generation circuit 184 repeats these operations. Bit-stream generation circuit 184 may entropy encode the residual data.

FIG. 5B is similar to FIG. 5A. However, rather than generating residual data sequentially, FIG. 5B illustrates an example where residual data is being generated in parallel. For example, PPC0 186A to PPC3 186D each represent different examples of PPC 180. In some examples, PPC0 186A to PPC3 186D may operate at a fourth of the speed as PPC 180, but because PPC0 186A to PPC3 186D generate the residual data in parallel and PPC 180 generates the residual data sequentially, the processing time may be the same. As noted above, because tiles are independently encodable, PPC0 186A to PPC3 186D are able to generate the residual data in parallel.

In the example illustrated in FIG. 5B, each one of PPC0 186A to PPC3 186D may include respective ones of cache 128 (FIG. 2), resulting in there being four caches like cache 128. In the example illustrated in FIG. 5A, only one cache 128 may be needed for PPC 180.

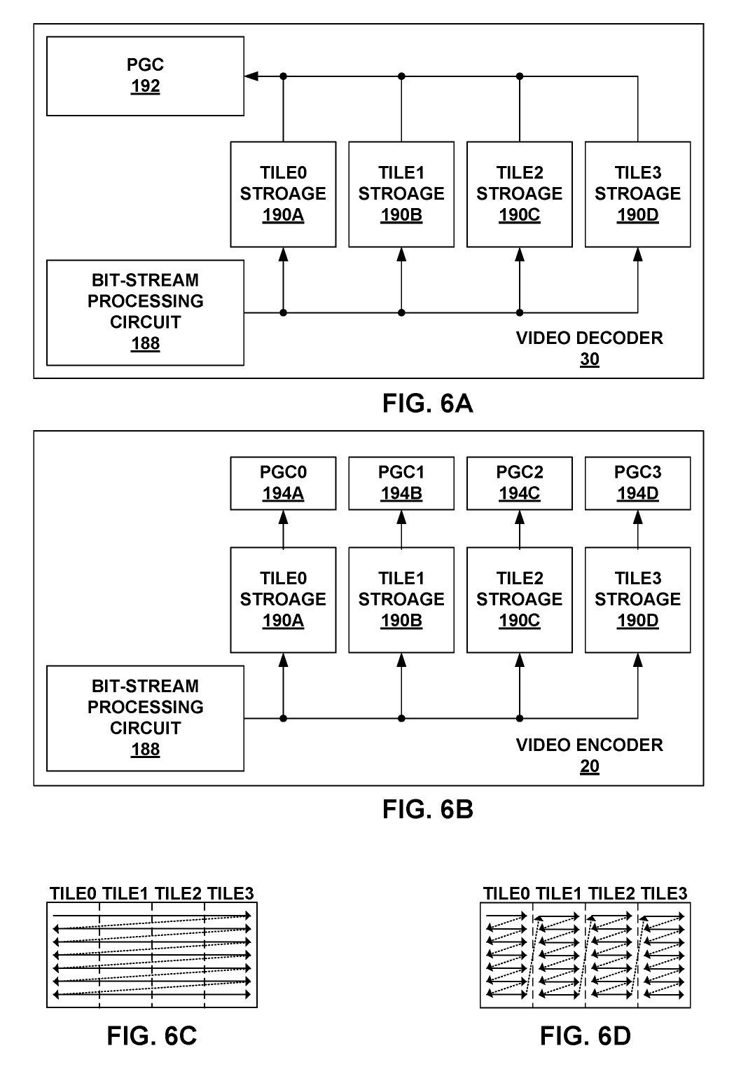

FIGS. 6A-6D illustrate examples for utilizing the tile based decoding, and are described together. For ease of description, FIGS. 6A-56 describe a frame being divided into four tiles, but more or fewer tiles are possible. FIG. 6A is a block diagram illustrating an example of processing tile-based video data for video decoding, FIG. 6B is a block diagram illustrating another example of processing tile-based video data for video encoding, FIG. 6C is a conceptual diagram illustrating reading of video data in tile-by-tile format for video decoding, and FIG. 6D is a conceptual diagram illustrating storage of video data in tile-by-tile format for video decoding.

In FIG. 6A, bit-stream processing circuit 188, an example of which is entropy decoding unit 150, may decode coefficient values from the bit-stream and store the values in tile0 storage 190A to tile3 storage 190D as illustrated in FIG. 6C. For instance, bit-stream processing circuit 188 may store coefficient values that correspond to a first subset of macroblocks of a first row of a frame in tile0 storage 190A, bit-stream processing circuit 188 may store coefficient values that correspond to a second subset of macroblocks of the first row of the frame in tile1 storage 190B, and so forth until bit-stream processing circuit 188 stores the last subset of macroblocks of the first row of the frame in tile3 storage 190D. Bit-stream processing circuit 188 may repeat these operations for all of the coefficient values for the macroblocks of the frame.

Pixel generation circuit (PGC) 192 may read coefficient values from tile0 storage 190A to tile3 storage 190D in the manner illustrated in FIG. 6C. An example of PGC 192 is the circuits that form prediction processing unit 152, inverse quantization unit 154, inverse transform processing unit 156, and reconstruction unit 158. For instance, PGC 192 may read all of the coefficient values from tile0 storage 190A in the manner illustrated in FIG. 6D, and generate reconstructed pixels for tile0. PGC 192 may read all of the coefficient values from tile0 storage 190B in the manner illustrated in FIG. 6D, and generate reconstructed pixels for tile1, and so forth, to reconstruct the entire frame.

FIG. 6B is similar to FIG. 6A. However, rather than generating reconstruct pixels sequentially, FIG. 6B illustrates an example where pixel data is being generated in parallel. For example, PGC0 194A to PGC3 194D each represent different examples of PGC 192. In some examples, PGC0 194A to PGC3 194D may operate at a fourth of the speed as PGC 192, but because PGC0 194A to PGC3 194D generate the residual data in parallel and PGC 192 generates the residual data sequentially, the processing time may be the same. As noted above, because tiles are independently decodable, PGC0 194A to PGC3 194D are able to reconstruct the pixels in different tiles in parallel.

In the example illustrated in FIG. 6B, each one of PGC0 194A to PGC3 194D may include respective ones of cache 128, resulting in there being four caches like cache 128. In the example illustrated in FIG. 6A, only one cache 128 may be needed for PGC 192.

As described above, tiles may be independently encodable and decodable. However, in the H.264 and VP8 standards certain pixels in another tile may be needed for encoding/decoding pixels in a current tile. For instance, FIG. 7 is a conceptual diagram illustrating last macroblocks in each row of a plurality of tiles. As illustrated, tile0 includes macroblocks 196A-196N, which are the macroblocks on the right-end of tile0, tile1 includes macroblocks 198A-198N, which are the macroblocks on the right-end of tile1, tile2 includes macroblocks 200A-200N, which are the macroblocks on the right-end of tile2, and tile3 includes macroblocks 202A-202N, which are the macroblocks on the right-end of tile3.

In some examples, for the last macroblocks of tile0 to tile2, the macroblock to its right and top (top-right) in next tile may not be ready (e.g., may not have been processed), but information about this top-right macroblock may be needed. For example, where each tile is being encode or decoded sequentially, the macroblock in tile1 that is to the top-right of macroblock 196B in tile0 may not have yet been encoded or decoded. However, macroblock information, such as motion vector information or intra-prediction mode, may be needed for such a top-right macroblock.

As one example, to encode macroblocks, video encoder 20 may utilize a merge mode or skip mode. In both merge mode and skip mode, video encoder 20 generates a list of candidate motion vectors from motion vectors of neighboring blocks, and selects a motion vector from this list of candidate motion vectors as the motion vector for the current block. For the merge mode, video encoder 20 also generates residual data between the block to which the selected motion vector will refer and the current block. For skip mode, video encoder 20 may not generate any residual data, in which case the values of the block referred to by the selected motion vector are copied as the values for the current block by video decoder 30.

Another example technique to encode macroblocks is based on a motion vector difference (MVD). In this example, video encoder 20 may determine a motion vector predictor based on motion vectors of neighboring blocks (e.g., by averaging the motion vectors), and determine a motion vector difference between the motion vector predictor and a motion vector for the current macroblock. Video decoder 30 may similarly determine the motion vector predictor and utilize the motion vector difference to determine the motion vector for the current block.

For the skip and merge modes, to generate the list of candidate motion vectors, and examples where MVD is used, one of the neighboring blocks may be the block located to the top-right of the last macroblocks in tiles0 to tile2, and therefore, the motion vector of the top-right block may be needed. However, because the top-right block has not been encoded, its motion vector may be unknown.

As another example, for intra-prediction, one intra-prediction mode is the top-right mode where pixel values from the top-right block are used to generate the predictive block. However, for the last macroblocks in each one of tiles0 to tiles2, the pixel values for the top-right blocks may not be known.

In examples described in this disclosure, there may be various ways to address these issues. As one example, prediction processing unit 100 may not allow intra-prediction processing unit 126 to use the top-right intra mode for macroblocks 196, 198, and 200. One way for prediction processing unit 100 to not allow intra-prediction processing unit 126 to use the top-right intra mode is by indicating to intra-prediction processing unit 126 that top-right blocks are unavailable. In this way, the pixel values for the macroblocks to the top-right of macroblocks 196, 198, and 200 would not be needed.

In some examples, rather than inter-prediction, prediction processing unit 100 may determine that each macroblock in the last row should be intra-predicted (but possibly without using top-right intra-mode). This way, the issues described with inter-prediction may not be present.

If inter-prediction is to be used, prediction processing unit 100 may not allow inter-prediction processing unit 120 to inter-predict macroblocks 196, 198, and 200 in skip mode or merge mode (e.g., force non-skip and non-merge). As another example, prediction processing unit 100 may generate the candidate list of motion vectors for skip and merge mode, but not include a motion vector for the top-right block.

As another example, prediction processing unit 100 may wait until after the top-right blocks are processed, and store the motion information (e.g., motion vector information) for the top-right blocks. Prediction processing unit 100 may then re-determine or determine for the first-time candidate list. Inter-prediction processing unit 120 may then determine the motion vector for the macroblock using merge mode or skip mode. This example may affect parallel processing capabilities, but the benefit of a smaller cache 128 may still be present.

For the MVD based inter-prediction, prediction processing unit 100 may perform similar operations as those of merge or skip mode. As one example, prediction processing unit 100 may not allow inter-prediction processing unit 120 to use MVD based inter-prediction for macroblocks 196, 198, and 200. As another example, prediction processing unit 100 may determine a motion vector predictor based on motion vectors other than that of the top-right blocks. As yet another example, prediction processing unit 100 may wait until after the top-right blocks are processes, and store the motion information for the top-right blocks. Prediction processing unit 100 may then re-determine or determine for the first-time the motion vector predictor. Inter-prediction processing unit 120 may then determine the MVD based on the motion vector predictor and the motion vector for the macroblock. This example may affect parallel processing capabilities, but the benefit of a smaller cache 128 may still be present.

As another example, prediction processing unit 100 may determine that the first block in each row is to be intra-mode predicted. This has the effect that blocks located to a top-right of respective last macroblocks 196, 198, and 200 are inter-mode encoded. This means that there is no motion vector information for the top-right blocks. Accordingly, inter-prediction processing unit 120 may apply skip mode, merge mode, or MVD based inter-prediction without any changes because prediction processing unit 100 may have already determined that the top-right blocks are all intra-mode encoded.

FIG. 8 is a conceptual diagram illustrating examples for processing last macroblocks in each row of a plurality of tiles. In the example illustrated in FIG. 8, block 204 is a macroblock or a partition of a macroblock. As noted above, the term macroblock is used to refer to both the case where the macroblock is not partitioned and to the case where the macroblock is partitioned and inter-prediction or intra-prediction is performed on the smaller partitioned sub-blocks. For instance, determining a motion vector for a macroblock, residual data for the macroblock, etc., encompasses determining a motion vector, residual data, etc. for one or more of the sub-blocks of the macroblock.

Block 204 may be the last block in a row of tile0. The division between tile0 and tile1 is illustrated by boundary 226. In some examples, tile0 and tile1 may be independently encodable and decodable.

In FIG. 8, the block top-right of block 204 is block 216. However, block 216 may not be available (e.g., not processed) when block 204 is to be processed (e.g., encoded or decoded). In this example, the pixel values for block 216 or the motion information for block 216 may not have been available by the time block 204 is to be encoded. Accordingly, in one example, prediction processing unit 100 may not allow block 204 to be intra mode coded in the top-right intra mode, or may force block 204 to be intra-predicted (but not in the top-right intra mode to avoid issues with inter-prediction). If inter-prediction is used, prediction processing unit 100 may not allow skip mode or merge mode for block 204, or allow skip mode and merge mode but with limited neighboring blocks. Similarly, prediction processing unit 100 may not use MVD for block 204 or allow MVD but with limited neighboring blocks to generate the motion vector predictor.

In some examples, prediction processing unit 100 may wait until information for block 216 is available, and then perform intra-prediction with top-right intra mode, skip mode, merge mode, or MVD for block 204. In some examples, prediction processing unit 100 may recalculate one or more of macroblock type and motion vector difference for block 204. For instance, after completing tile0 or in parallel with tile0, PPC 180 may encode tile1. In this example, after PPC 180 (e.g., via prediction processing unit 100) determines the prediction information (e.g., inter- or intra-prediction mode, motion vector, macroblock size, etc.) of block 216, which is the top-right block to block 204, PPC 180 may calculate the macroblock type and motion vector difference(s) (MVD(s)) for block 204 based on the encoding of the respective blocks located to the top-right (e.g., based on the motion vector and macroblock type). In some examples, PPC 180 may not recalculate the residual data as there may be no change to the motion vector itself. However, there may be a change to the predictors based on the now available information for the respective top-right blocks. Although PPC 180 is described as performing such calculations, entropy encoding unit 118 may perform such calculations.

As an example, PPC 180 (e.g., via prediction processing unit 100) may determine the MVD for block 204, but in determining this MVD may assume that block 216 is intra-predicted or unavailable. PPC 180 (e.g., via prediction processing unit 100) may actually determine motion information (e.g., motion vector) for block 216 as part of encoding block 216. PPC 180 (or possibly bit-stream generation circuit 184) may calculate a macroblock type and/or MVD for block 204 based on the encoding of block 216 (e.g., based on the motion information such as motion vector of block 216). PPC 180 or bit-stream generation circuit 184 may not need to recalculate the residual data; however, recalculation of the residual data may be possible.

Although the above example of recalculating motion information for block 204 is described with respect to encoding, the example techniques are not so limited. In some examples, video decoder 30 (e.g., via bit-stream processing circuit 188 and PGC 192) may perform the inverse operations as part of video decoding.

There may be additional constraints that may be placed for conforming to the H.264 or VP8 standards. As one example, if macroblock level quantization parameter changes are enabled, prediction processing unit 100 may force the first macroblock in a row to be INTRA 16×16 for deltaQp coding. In some examples, if all partitions in a block are B-direct, prediction processing unit 100 may designate that block type to be B-direct 16×16.

Also, in the above example, block 204 is being encoded. However, when block 220 is to be encoded, information from blocks 204, 206, 208, and 210 may be needed. Accordingly, prediction processing unit 100 may store the motion vector and quantization parameters for blocks 204, 206, 208, and 210 as part of a vertical buffer, and the use that data when determining the motion information for block 220. For instance, the MVD for block 204 may be calculated and stored in the vertical buffer and then sent as part of encoding block 220. The vertical buffer may also be used for pre-DB pixel management for loop filtering.

The above example constrains on block 204 may be part of generating the residual data for block 204. For instance, prediction processing unit 100 may determine that block 204 is to be intra-mode encoded, and intra-prediction processing unit 126 may generate residual data based on the determination that block 204 is to be intra-mode encoded.

As another example, prediction processing unit 100 may determine that block 216 (e.g., block top-right of block 204) is intra-mode encoded, and inter-prediction processing unit 120 may generate residual data based on the determination that block 216 is intra-mode encoded. In some examples, prediction processing unit 100 may determine that block 216 is unavailable for generating residual data for block 204, and may generate residual data for block 204 based on the determination that block 216 is unavailable (e.g., not use motion vector for block 216 for skip mode, merge mode, and MVD generation).

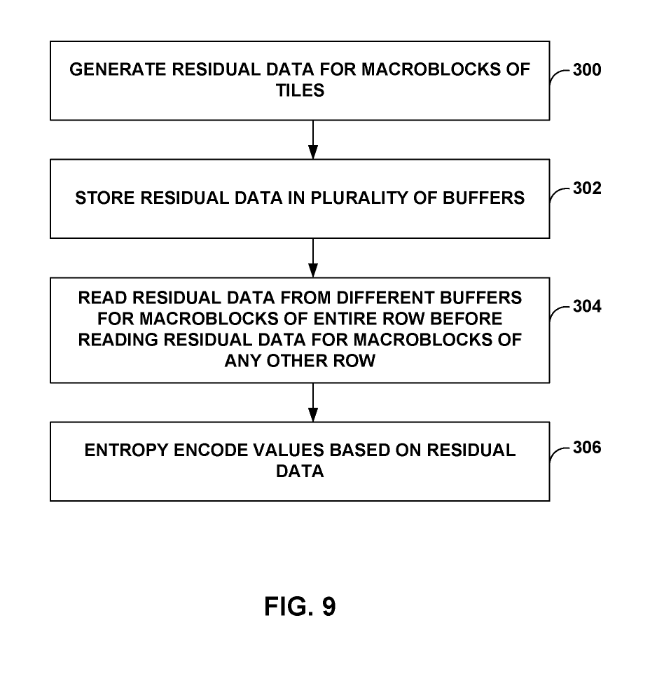

FIG. 9 is a flowchart illustrating an example operation of processing video data. For purposes of illustration, the examples are illustrated with respect to video encoder 20, and FIG. 5A.

PPC 180 may generate residual data for macroblocks for a plurality of tiles of a current frame (300). Each tile includes a plurality of macroblocks, and each tile is independently encoded from the other tiles in the current frame. The width of the tile is less than a width of the current frame.

To generate residual data for macroblocks, PPC 180 (e.g., via prediction processing unit 100) may retrieve pixel values for storage in cache 128, where a width of cache 128 is equal to a width of a tile and less than the width of the current frame. PPC 180 (e.g., via prediction processing unit 100) may determine a difference between pixel values of the macroblocks and the pixel values stored in cache 128. PPC 180 (e.g., via one of residual generation unit 102, transform processing unit 104, or quantization unit 106) may generate the residual data based on the determined difference.

There may be various ways in which PPC 180 may generate residual data for macroblocks. As one example, PPC 180 (e.g., via prediction processing unit 100) may determine that respective blocks located to a top-right of respective last macroblocks 196, 198, and 200 in rows of the plurality of tiles are intra-mode encoded, and may generate residual data for the respective last macroblocks 196, 198, and 200 based on the determination that the respective blocks located to the top-right are intra-mode encoded. As another example, PPC 180 (e.g., via prediction processing unit 100) may determine that respective blocks located to the top-right of respective last macroblocks 196, 198, and 200 in rows of the plurality of tiles are unavailable for generating residual data for the respective last macroblocks 196, 198, and 200.

In some examples, prediction processing unit 100 may recalculate one or more of macroblock type and motion vector difference for respective last macroblocks 196, 198, and 200. For instance, after completing tile0 or in parallel with tile0, PPC 180 may encode tile1. In this example, after PPC 180 (e.g., via prediction processing unit 100) determines the prediction information (e.g., inter- or intra-prediction mode, motion vector, macroblock size, etc.) of the respective top-right blocks to the respective last macroblocks 196, 198, and 200, PPC 180 may calculate the macroblock type and motion vector difference(s) (MVD(s)) for respective last macroblocks 196, 198, and 200 based on the encoding of the respective blocks located to the top-right (e.g., based on the motion vector and macroblock type). In some examples, PPC 180 may not recalculate the residual data as there may be no change to the motion vector itself. However, there may be a change to the predictors based on the now available information for the respective top-right blocks. Although PPC 180 is described as performing such calculations, entropy encoding unit 118 may perform such calculations.

In the example illustrated in FIG. 5A, PPC 180 may generate the residual data for macroblocks of the plurality of tiles in sequential tile order (e.g., first tile, then second tile, and so forth). However, the example illustrated in FIG. 5B may operate similar to the example illustrated in FIG. 5A, but PPC0 186A to PPC3 186D may generate the residual data for macroblocks of two or more of the plurality of tiles in parallel.

PPC 180 may store the residual data in a plurality of buffers, where each buffer is associate with one or more tiles, and each buffer is configured to store residual data for macroblocks for the one or more tiles with which each buffer is associated (302). For example, in FIGS. 5A and 5B, tile0 storage 182A to tile0 storage 182D are associated with respective ones of tiles0 to tile3. Tile0 storage 182A may store residual data for macroblocks of tile0, tile1 storage 182B may store residual data for macroblocks of tile1, and so forth. Each buffer may also store motion vector differences (MVDs), intra mode information, macroblock type, quantization parameters, and other such information needed to encode or decode the macroblock such as in an entropy encoder or decoder.

Bit-stream generation circuit 184 may read the residual data from different buffers for macroblocks of an entire row of the current frame before reading residual data from different buffers for macroblocks of any other row of the current frame (304). For instance, bit-stream generation circuit 184 may read residual data in the manner illustrated in FIG. 5D. As one example, bit-stream generation circuit 184 may read residual data for macroblocks of a first row from tile0 storage 182A, then read residual data for macroblocks of a first row from tile1 storage 182B, and so forth such that bit-stream generation circuit 184 reads residual data for macroblocks from each one of tile0 storage 182A to tile3 storage 182D for a first row of the current frame before reading residual data for macroblocks of any of the other rows for the current frame.

Bit-stream generation circuit 184 (e.g., via entropy encoding unit 118) may entropy encode values based on the read residual data (306). In this way, video encoder 20 may generate a bit-stream that conforms to the requirements of H.264 or VP8, while benefiting from tile based coding techniques.

The techniques described above may be performed by video encoder 20 (FIGS. 1 and 2) and/or video decoder 30 (FIGS. 1 and 3), both of which may be generally referred to as a video coder. Likewise, video coding may refer to video encoding or video decoding, as applicable. In addition, video encoding and video decoding may be generically referred to as “processing” video data.

It should be understood that all of the techniques described herein may be used individually or in combination. This disclosure includes several signaling methods which may change depending on certain factors such as block size, slice type etc. Such variation in signaling or inferring the syntax elements may be known to the encoder and decoder a-priori or may be signaled explicitly in the video parameter set (VPS), sequence parameter set (SPS), picture parameter set (PPS), slice header, at a tile level or elsewhere.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially. In addition, while certain aspects of this disclosure are described as being performed by a single module or unit for purposes of clarity, it should be understood that the techniques of this disclosure may be performed by a combination of units or modules associated with a video coder.

While particular combinations of various aspects of the techniques are described above, these combinations are provided merely to illustrate examples of the techniques described in this disclosure. Accordingly, the techniques of this disclosure should not be limited to these example combinations and may encompass any conceivable combination of the various aspects of the techniques described in this disclosure.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the claims.

What is claimed is:

1. A method of encoding video data, the method comprising:
generating residual data for macroblocks for a plurality of tiles of a current frame, wherein each tile includes a plurality of macroblocks, wherein each tile is independently encoded from the other tiles of the current frame, and wherein a width of each tile is less than a width of the current frame;
storing the residual data in a plurality of buffers, wherein each buffer is associated with one or more tiles, and wherein each buffer is configured to store residual data for macroblocks for the one or more tiles with which each buffer is associated;
reading the residual data from the plurality of buffers for macroblocks of an entire row of the current frame before reading residual data from the plurality of buffers for macroblocks of any other row of the current frame; and
encoding values based on the read residual data.

2. The method of claim 1, wherein generating residual data for macroblocks comprises:
retrieving pixel values, for at least predictive block, for storage in a cache, wherein a width of the cache is equal to a width of a tile and less than the width of the current frame;
determining a difference between pixel values of the macroblocks and the pixel values stored in the cache; and
generating the residual data based on the determined difference.

3. The method of claim 1, wherein generating residual data for macroblocks comprises:
determining that respective blocks located to a top-right of respective last macroblocks in rows of the plurality of tiles are one of intra-mode encoded or unavailable; and
generating residual data for the respective last macroblocks in rows based on the determination that the respective blocks located to the top-right are one of intra-mode encoded or unavailable.

4. The method of claim 3, further comprising:
encoding respective blocks located to the top-right of respective last macroblocks in rows of the plurality of tiles; and
calculating one or more of macroblock type and motion vector difference for respective last macroblocks in the rows of the plurality of tiles based on the encoding of respective blocks located to the top-right.

5. The method of claim 1, wherein generating residual data comprises generating residual data for macroblocks of two or more tiles of the plurality of tiles in parallel.

6. The method of claim 1, wherein generating residual data comprises generating residual data for macroblocks of the plurality of tiles in sequential tile order.

7. The method of claim 1, wherein encoding the values comprises entropy encoding the values based on the determined difference.

8. The method of claim 1, wherein each buffer is configured to store motion vector differences (MVDs), intra mode information, macroblock type, and quantization parameters used for encoding.

9. A device for encoding video data, the device comprising:
a plurality of buffers;
one or more pixel processing circuits configured to:
generate residual data for macroblocks for a plurality of tiles of a current frame, wherein each tile includes a plurality of macroblocks, wherein each tile is independently encoded from the other tiles of the current frame, and wherein a width of each tile is less than a width of the current frame; and
store the residual data in the plurality of buffers, wherein each buffer is associated with one or more tiles, and wherein each buffer is configured to store residual data for macroblocks for the one or more tiles with which each buffer is associated; and
a bit-stream generation circuit configured to:
read the residual data from the plurality of buffers for macroblocks of an entire row of the current frame before reading residual data from the plurality of buffers for macroblocks of any other row of the current frame; and
encode values based on the read residual data.

10. The device of claim 9, wherein to generate residual data for macroblocks, the one or more pixel processing circuits are configured to:
retrieve pixel values, for at least one predictive block, for storage in a cache, wherein a width of the cache is equal to a width of a tile and less than the width of the current frame;
determine a difference between pixel values of the macroblocks and the pixel values stored in the cache; and
generate the residual data based on the determined difference.

11. The device of claim 9, wherein to generate residual data for macroblocks, the one or more pixel processing circuits are configured to:
determine that respective blocks located to a top-right of respective last macroblocks in rows of the plurality of tiles are intra-mode encoded are one of intra-mode encoded or unavailable; and
generate residual data for the respective last macroblocks in rows based on the determination that the respective blocks located to the top-right are one of intra-mode encoded or unavailable.

12. The device of claim 11, wherein the one or more pixel processing circuits are configured to determine motion information for respective blocks located to the top-right of respective last macroblocks of the plurality of tiles, and calculate one or more of macroblock type and motion vector difference for respective last macroblocks in the rows of the plurality of tiles based on the determined motion information of respective blocks located to the top-right.

13. The device of claim 9, wherein the one or more pixel processing circuits include two or more pixel processing circuits, and wherein to generate residual data, the two or more pixel processing circuits are configured to generate residual data for macroblocks of two or more tiles of the plurality of tiles in parallel.

14. The device of claim 9, wherein to generate residual data, the one or more pixel processing circuits are configured to generate residual data for macroblocks of the plurality of tiles in sequential tile order.

15. The device of claim 9, wherein to encode the values, the bit-stream generation circuit is configured to entropy encode the values based on the determined difference.

16. The device of claim 9, wherein each buffer is configured to store motion vector differences (MVDs), intra mode information, macroblock type, and quantization parameters used for encoding.

17. A device for encoding video data, the device comprising:
means for generating residual data for macroblocks for a plurality of tiles of a current frame, wherein each tile includes a plurality of macroblocks, wherein each tile is independently encoded from the other tiles of the current frame, and wherein a width of each tile is less than a width of the current frame;
means for storing the residual data in a plurality of buffers, wherein each buffer is associated with one or more tiles, and wherein each buffer is configured to store residual data for macroblocks for the one or more tiles with which each buffer is associated;
means for reading the residual data from the plurality of buffers for macroblocks of an entire row of the current frame before reading residual data from the plurality of buffers for macroblocks of any other row of the current frame; and
means for encoding values based on the read residual data.

18. The device of claim 17, wherein the means for generating residual data for macroblocks comprises:
means for retrieving pixel values, for at least predictive block, for storage in a cache, wherein a width of the cache is equal to a width of a tile and less than the width of the current frame;
means for determining a difference between pixel values of the macroblocks and the pixel values stored in the cache; and
means for generating the residual data based on the determined difference.

19. The device of claim 17, wherein the means for generating residual data for macroblocks comprises:
means for determining that respective blocks located to a top-right of respective last macroblocks in rows of the plurality of tiles are one of intra-mode encoded or unavailable; and
means for generating residual data for the respective last macroblocks in rows based on the determination that the respective blocks located to the top-right are one of intra-mode encoded or unavailable.

20. The device of claim 19, further comprising:
means for encoding respective blocks located to the top-right of respective last macroblocks in rows of the plurality of tiles; and
means for calculating one or more of macroblock type and motion vector difference for respective last macroblocks in the rows of the plurality of tiles based on the encoding of respective blocks located to the top-right.

21. The device of claim 17, wherein the means for generating residual data comprises means for generating residual data for macroblocks of two or more tiles of the plurality of tiles in parallel.

22. The device of claim 17, wherein the means for generating residual data comprises means for generating residual data for macroblocks of the plurality of tiles in sequential tile order.

23. The device of claim 17, wherein the means for encoding the values comprises means for entropy encoding the values based on the determined difference.

24. A computer-readable storage medium storing instructions that when executed cause one or more processors of a device for encoding video data to:
generate residual data for macroblocks for a plurality of tiles of a current frame, wherein each tile includes a plurality of macroblocks, wherein each tile is independently encoded from the other tiles of the current frame, and wherein a width of each tile is less than a width of the current frame;
store the residual data in a plurality of buffers, wherein each buffer is associated with one or more tiles, and wherein each buffer is configured to store residual data for macroblocks for the one or more tiles with which each buffer is associated;
read the residual data from the plurality of buffers for macroblocks of an entire row of the current frame before reading residual data from the plurality of buffers for macroblocks of any other row of the current frame; and
encode values based on the read residual data.

25. The computer-readable storage medium of claim 24, wherein the instructions that cause the one or more processors to generate residual data for macroblocks comprise instructions that cause the one or more processors to:
retrieve pixel values, for at least predictive block, for storage in a cache, wherein a width of the cache is equal to a width of a tile and less than the width of the current frame;
determine a difference between pixel values of the macroblocks and the pixel values stored in the cache; and
generate the residual data based on the determined difference.

26. The computer-readable storage medium of claim 24, wherein the instructions that cause the one or more processors to generate residual data for macroblocks comprise instructions that cause the one or more processors to:
determine that respective blocks located to a top-right of respective last macroblocks in rows of the plurality of tiles are one of intra-mode encoded or unavailable; and
generate residual data for the respective last macroblocks in rows based on the determination that the respective blocks located to the top-right are one of intra-mode encoded or unavailable.

27. The computer-readable storage medium of claim 26, further comprising instructions that cause the one or more processors to:
encode respective blocks located to the top-right of respective last macroblocks in rows of the plurality of tiles; and
calculate one or more of macroblock type and motion vector difference for respective last macroblocks in the rows of the plurality of tiles based on the encoding of respective blocks located to the top-right.

28. The computer-readable storage medium of claim 24, wherein the instructions that cause the one or more processors to generate residual data for macroblocks comprise instructions that cause the one or more processors to generate residual data for macroblocks of two or more tiles of the plurality of tiles in parallel.

29. The computer-readable storage medium of claim 24, wherein the instructions that cause the one or more processors to generate residual data for macroblocks comprise instructions that cause the one or more processors to generate residual data for macroblocks of the plurality of tiles in sequential tile order.

30. The computer-readable storage medium of claim 24, wherein the instructions that cause the one or more processors to encode the values comprise instructions that cause the one or more processors to entropy encode the values based on the determined difference.
